(19) United States
(12) Patent Application Publication
(10) Pub. No.: US 2022/0147851 A1
(43) Pub. Date: May 12, 2022

(54) LEARNING DEVICE, LEARNING METHOD, LEARNING DATA GENERATION DEVICE, LEARNING DATA GENERATION METHOD, INFERENCE DEVICE, AND INFERENCE METHOD

(71) Applicant: Mitsubishi Electric Corporation, Tokyo (JP)

(72) Inventor: Genta YOSHIMURA, Tokyo (JP)

(73) Assignee: Mitsubishi Electric Corporation, Tokyo (JP)

(21) Appl. No.: 17/581,043

(22) Filed: Jan. 21, 2022

Related U.S. Application Data
(63) Continuation of application No. PCT/JP2019/035133, filed on Sep. 6, 2019.

(51) Int. Cl. G06N 5/04

(52) U.S. Cl. CPC G06N 5/048

(57) ABSTRACT

A learning device includes: a learning data acquiring unit to acquire a plurality of pieces of learning data in which one piece of learning data is a combination of first information based on one of one or a plurality of pieces of time-series data including observation values in time series, second information based on one of a plurality of prediction periods including at least two prediction periods different from each other, and third information based on observation values after a lapse of the prediction period; and a learning unit to perform learning using the plurality of pieces of learning data acquired using information obtained by combining the first information and the second information in the learning data as an explanatory variable and using the third information as a response variable, and generate a learned model capable of inferring inference observation values after a lapse of a designated prediction period.

### CROSS REFERENCE TO RELATED APPLICATIONS

This application is a Continuation of PCT International Application No. PCT/JP2019/035133 filed on Sep. 6, 2019, which is hereby expressly incorporated by reference into the present application.

### TECHNICAL FIELD

The present invention relates to a learning device, a learning method, a learning data generation device, a learning data generation method, an inference device, and an inference method.

### BACKGROUND ART

An observation value at any future time point after the current date and time is inferred on the basis of time-series data including observation values in time series.

For example, for the inference of the observation value based on the time-series data, a model such as a time-series model, for example, an AR (Autoregressive) model, an MA (Moving Average) model, an ARMA (Autoregressive Moving Average) model, an ARIMA (Autoregressive Integrated Moving Average) model, or a SARIMA (Seasonal ARIMA) model, a state space model, for example, a dynamic linear model, a Kalman filter, or a particle filter, or an RNN (Recurrent neural network) model, for example, an LSTM (Long short-term memory) or a GRU (Gated Recurrent Unit) is used. These models infer an observation value at any future time point by repeating inference of a future observation value for a predetermined period, inference of a future potential state for a predetermined period, or the like a plurality of times.

In addition, for example, Patent Literature 1 discloses a method of inferring an observation value at any future time point by repeating inference of an observation value after a lapse of a predetermined period in accordance with a recurrence formula.

### CITATION LIST

### Patent Literature

Patent Literature 1: Japanese Patent Laid-open Publication No. 06-035895

### SUMMARY OF INVENTION

### Technical Problem

However, a conventional method of inferring an observation value at any future time point based on time-series data is a method of repeating inference of a future observation value and the like a plurality of times for a predetermined period. Therefore, the conventional method has a problem that inference errors generated for each inference of the future observation value for a predetermined period are accumulated, and thus an inference accuracy of the observation value at a far future time point degrades.

The present invention is intended to solve the above-described problems, and an object thereof is to provide a learning device that enables inference of an observation value having high inference accuracy with a small inference error in inference of any future observation value.

### Solution to Problem

A learning device according to the present invention includes: processing circuitry to perform a process to: acquire a plurality of pieces of learning data in which one piece of learning data is a combination of first information based on one of one or a plurality of pieces of time-series data including observation values in time series, second information based on one of a plurality of prediction periods including at least two prediction periods different from each other, and third information based on the observation values after a lapse of the prediction period; and perform learning using a plurality of pieces of the learning data acquired with information obtained by combining the first information and the second information in the learning data as an explanatory variable and the third information as a response variable, and generate a learned model capable of inferring an inference observation value after a lapse of the designated prediction period, wherein the second information is information obtained by encoding prediction period information capable of specifying the prediction period into vector representation having a predetermined number of dimensions, the process further to:

determine one or a plurality of virtual current dates and times, which are virtually determined current dates and times, from a period corresponding to one piece of original time-series data including the observation values in time series; segment, for each of one or a plurality of the virtual current dates and times determined, the original time-series data corresponding to a period before the virtual current date and time in the original time-series data as the time-series data including the observation values in time series that serve as a basis of the first information; determine, for each of one or a plurality of the virtual current dates and times determined, at least the two prediction periods that are different from each other and serve as a basis of the second information, a time point after a lapse of the prediction period being included in a period corresponding to the original time-series data; acquire, for each of at least the two prediction periods different from each other determined, the observation values after a lapse of the prediction period that serve as a basis of the third information, from the original time-series data; and generate a plurality of pieces of the learning data by combining the first information based on one of one or a plurality of pieces of the time-series data including the observation values in time series segmented, the second information based on one of a plurality of the prediction periods including at least the two prediction periods different from each other determined, and the third information based on the observation values after a lapse of the prediction period acquired, wherein

the process acquires a plurality of pieces of the learning data generated.

### Advantageous Effects of Invention

According to the present invention, it is possible to enable inference of an observation value having high inference accuracy with a small inference error in inference of any future observation value.

### BRIEF DESCRIPTION OF DRAWINGS

FIG. 1 is a block diagram illustrating an example of a configuration of a main part of an inference system according to a first embodiment.

FIG. 2 is a block diagram showing an example of a configuration of a main part of a learning device according to the first embodiment.

FIGS. 3A and 3B are diagrams showing an example of a hardware configuration of a main part of the learning device according to the first embodiment.

FIG. 4 is a diagram illustrating an example of original time-series data, a prediction period, first information, second information, third information, and learning data according to the first embodiment.

FIG. 5 is a block diagram illustrating an example of a configuration of a main part of a learning data generating unit according to the first embodiment.

FIG. 6 is a flowchart illustrating an example of processing of the learning data generating unit according to the first embodiment.

FIG. 7 is a diagram illustrating another example of original time-series data, a prediction period, first information, second information, third information, and learning data according to the first embodiment.

FIG. 8 is a flowchart illustrating an example of processing of the learning device according to the first embodiment.

FIG. 9 is a block diagram showing an example of a configuration of a main part of an inference device according to the first embodiment.

FIG. 10A is a diagram illustrating an example of inference time-series data, a designated prediction period, fourth information, fifth information, and an explanatory variable according to the first embodiment.

FIG. 10B is a diagram illustrating an example of an image displayed on a display device when a result output unit according to the first embodiment outputs inference observation values acquired by a result acquiring unit via a display control unit.

FIG. 11 is a flowchart illustrating an example of processing of the inference device according to the first embodiment.

FIG. 12 is a block diagram showing an example of a main part of an inference system according to a second embodiment.

FIG. 13 is a block diagram showing an example of a configuration of a main part of a learning device according to the second embodiment.

FIG. 14 is a flowchart illustrating an example of processing of the learning device according to the second embodiment.

FIG. 15 is a block diagram showing an example of a configuration of a main part of an inference device according to the second embodiment.

FIG. 16 is a diagram illustrating an example of an image displayed on a display device when a result output unit according to the second embodiment outputs inference observation values and quantile point information acquired by a result acquiring unit via a display control unit.

FIG. 17 is a flowchart illustrating an example of processing of the inference device according to the second embodiment.

FIG. 18 is a block diagram showing an example of a main part of an inference system according to a third embodiment.

FIG. 19 is a block diagram showing an example of a configuration of a main part of a learning device according to the third embodiment.

FIG. 20 is a flowchart explaining an example of processing of the learning device according to the third embodiment.

FIG. 21 is a block diagram showing an example of a configuration of a main part of an inference device according to the third embodiment.

FIG. 22 is a diagram illustrating an example of an image displayed on a display device when a result output unit according to the third embodiment outputs inference observation values and predicted distribution information acquired by a result acquiring unit via a display control unit.

FIG. 23 is a flowchart illustrating an example of processing of the inference device according to the third embodiment.

FIG. 24 is a block diagram showing an example of a main part of an inference system according to a fourth embodiment.

FIG. 25 is a block diagram showing an example of a configuration of a main part of an inference device according to the fourth embodiment.

FIG. 26 is a diagram illustrating an example of an image displayed on a display device when a result output unit according to the fourth embodiment outputs one or more inference observation values within a prediction range that is a prediction target acquired by a result acquiring unit via a display control unit.

FIG. 27 is a flowchart illustrating an example of processing of the inference device according to the fourth embodiment.

FIG. 28 is a diagram illustrating an example of an image displayed on the display device when the result output unit according to the fourth embodiment outputs, via the display control unit, respective quantile points of one or more inference observation values within a prediction range that is a prediction target acquired by the result acquiring unit.

FIG. 29 is a diagram illustrating an example of an image displayed on the display device when the result output unit according to the fourth embodiment outputs, via the display control unit, a predicted distribution of one or more inference observation values within a prediction range that is a prediction target acquired by the result acquiring unit.

### DESCRIPTION OF EMBODIMENTS

Hereinafter, embodiments of the present invention will be described in detail with reference to the drawings.

### First Embodiment.

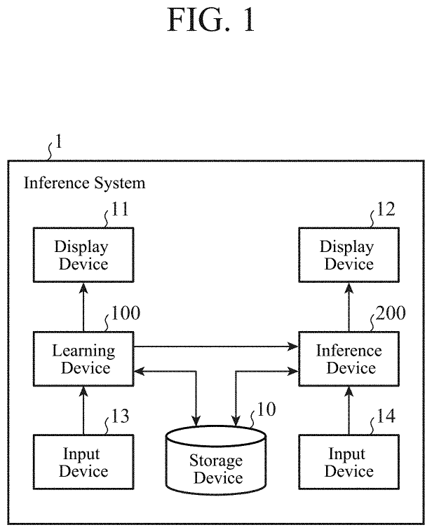

An inference system 1 according to a first embodiment will be described with reference to FIGS. 1 to 11.

FIG. 1 is a block diagram illustrating an example of a configuration of a main part of the inference system 1 according to the first embodiment.

The inference system 1 according to the first embodiment includes a learning device 100, an inference device 200, a storage device 10, display devices 11 and 12, and input devices 13 and 14.

The storage device 10 is a device for storing information necessary for the inference system 1 such as time-series data.

The storage device 10 includes a storage medium such as a solid state drive (SSD) or a hard disk drive (HDD) for storing the information.

The storage device 10 receives a read request from the learning device 100 or the inference device 200, reads information such as time-series data from the storage medium, and outputs the read information to the learning device 100 or the inference device 200 that has made the read request.

In addition, the storage device 10 receives a write request from the learning device 100 or the inference device 200, and stores information output from the learning device 100 or the inference device 200 in a storage medium.

The display devices 11 and 12 are devices for displaying an image such as a display.

The display device 11 receives an image signal output from the learning device 100 and displays an image corresponding to the image signal.

The display device 12 receives an image signal output from the inference device 200 and displays an image corresponding to the image signal.

The input devices 13 and 14 are devices for a user to perform operation input, such as a keyboard or a mouse.

The input device 13 receives an operation input from the user and outputs an operation signal corresponding to the input operation of the user to the learning device 100.

The input device 14 receives an operation input from the user and outputs an operation signal corresponding to the input operation of the user to the inference device 200.

The learning device 100 is a device that generates a learned model by performing machine learning based on time-series data and outputs the generated learned model as model information.

The inference device 200 is a device that inputs an explanatory variable to a learned model corresponding to a learning result by machine learning, acquires an observation value output by the learned model as an inference result, and outputs the acquired observation value. In the following description, an observation value output by the learned model as an inference result is referred to as an inference observation value.

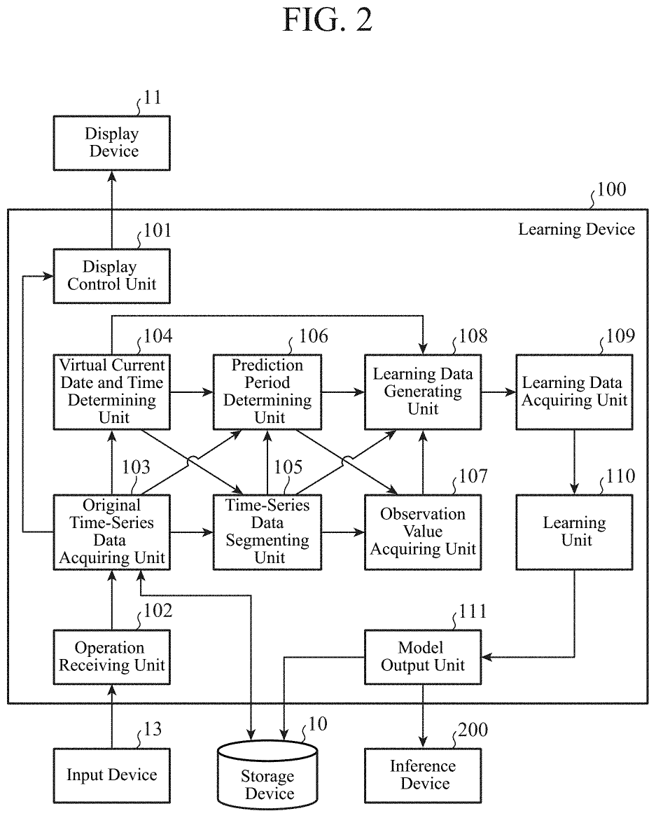

The learning device 100 according to the first embodiment will be described with reference to FIGS. 2 to 8.

FIG. 2 is a block diagram showing an example of a configuration of a main part of the learning device 100 according to the first embodiment.

The learning device 100 includes a display control unit 101, an operation receiving unit 102, an original time-series data acquiring unit 103, a virtual current date and time determining unit 104, a time-series data segmenting unit 105, a prediction period determining unit 106, an observation value acquiring unit 107, a learning data generating unit 108, a learning data acquiring unit 109, a learning unit 110, and a model output unit 111.

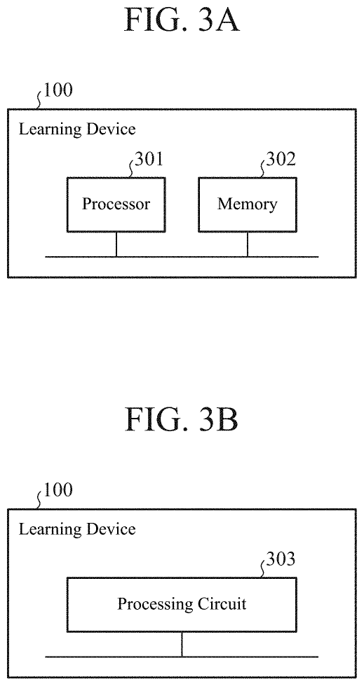

A hardware configuration of a main part of the learning device 100 according to the first embodiment will be described with reference to FIGS. 3A and 3B.

FIGS. 3A and 3B are diagrams showing an example of the hardware configuration of the main part of the learning device 100 according to the first embodiment.

As illustrated in FIG. 3A, the learning device 100 is configured by a computer, and the computer includes a processor 301 and a memory 302. The memory 302 stores programs for causing the computer to function as the display control unit 101, the operation receiving unit 102, the original time-series data acquiring unit 103, the virtual current date and time determining unit 104, the time-series data segmenting unit 105, the prediction period determining unit 106,the observation value acquiring unit 107, the learning data generating unit 108, the learning data acquiring unit 109, the learning unit 110, and the model output unit 111. The processor 301 reads and executes the programs stored in the memory 302, thereby implementing the display control unit 101, the operation receiving unit 102, the original time-series data acquiring unit 103, the virtual current date and time determining unit 104, the time-series data segmenting unit 105, the prediction period determining unit 106, the observation value acquiring unit 107, the learning data generating unit 108, the learning data acquiring unit 109, the learning unit 110, and the model output unit 111.

In addition, as illustrated in FIG. 3B, the learning device 100 may be configured by a processing circuit 303. In this case, the functions of the display control unit 101, the operation receiving unit 102, the original time-series data acquiring unit 103, the virtual current date and time determining unit 104, the time-series data segmenting unit 105, the prediction period determining unit 106, the observation value acquiring unit 107, the learning data generating unit 108, the learning data acquiring unit 109, the learning unit 110, and the model output unit 111 may be implemented by the processing circuit 303.

Furthermore, the learning device 100 may include a processor 301, a memory 302, and a processing circuit 303 (not illustrated). In this case, some of the functions of the display control unit 101, the operation receiving unit 102, the original time-series data acquiring unit 103, the virtual current date and time determining unit 104, the time-series data segmenting unit 105, the prediction period determining unit 106, the observation value acquiring unit 107, the learning data generating unit 108, the learning data acquiring unit 109, the learning unit 110, and the model output unit 111 may be implemented by the processor 301 and the memory 302, and the remaining functions may be implemented by the processing circuit 303.

The processor 301 uses, for example, a central processing unit (CPU), a graphics processing unit (GPU), a microprocessor, a microcontroller, or a digital signal processor (DSP).

The memory 302 uses, for example, a semiconductor memory or a magnetic disk. More specifically, the memory 302 uses a random access memory (RAM), a read only memory (ROM), a flash memory, an erasable programmable read only memory (EPROM), an electrically erasable programmable read-only memory (EEPROM), an SSD, an HDD, or the like.

The processing circuit 303 uses, for example, an application specific integrated circuit (ASIC), a programmable logic device (PLD), a field-programmable gate array (FPGA), a system-on-a-chip (SoC), or a system large-scale integration (LSI).

The display control unit 101 generates an image signal corresponding to an image to be displayed on the display device 11, and outputs the generated image signal to the display device 11. The image to be displayed on the display device 11 is an image indicating a list of time-series data stored in the storage device 10.

Upon receiving the operation signal output from the input device 13, the operation receiving unit 102 outputs operation information indicating a user's input operation corresponding to the operation signal to the original time-series data acquiring unit 103 and the like.

The operation information output from the operation receiving unit 102 is, for example, information indicating time-series data designated by a user's input operation in the time-series data stored in the storage device 10.

The learning data acquiring unit 109 acquires a plurality of pieces of learning data. One piece of learning data is a combination of first information, second information, and third information. The first information is information based on one of one or a plurality of pieces of time-series data including observation values in time series. The second information is information based on one of a plurality of prediction periods including at least two prediction periods different from each other. The third information is information based on observation values after a lapse of the prediction period.

The learning data acquiring unit 109 acquires, for example, a plurality of pieces of learning data generated by the original time-series data acquiring unit 103, the virtual current date and time determining unit 104, the time-series data segmenting unit 105, the prediction period determining unit 106, the observation value acquiring unit 107, and the learning data generating unit 108.

The learning data acquiring unit 109 may acquire a plurality of pieces of learning data by reading a plurality of pieces of learning data from the storage device 10.

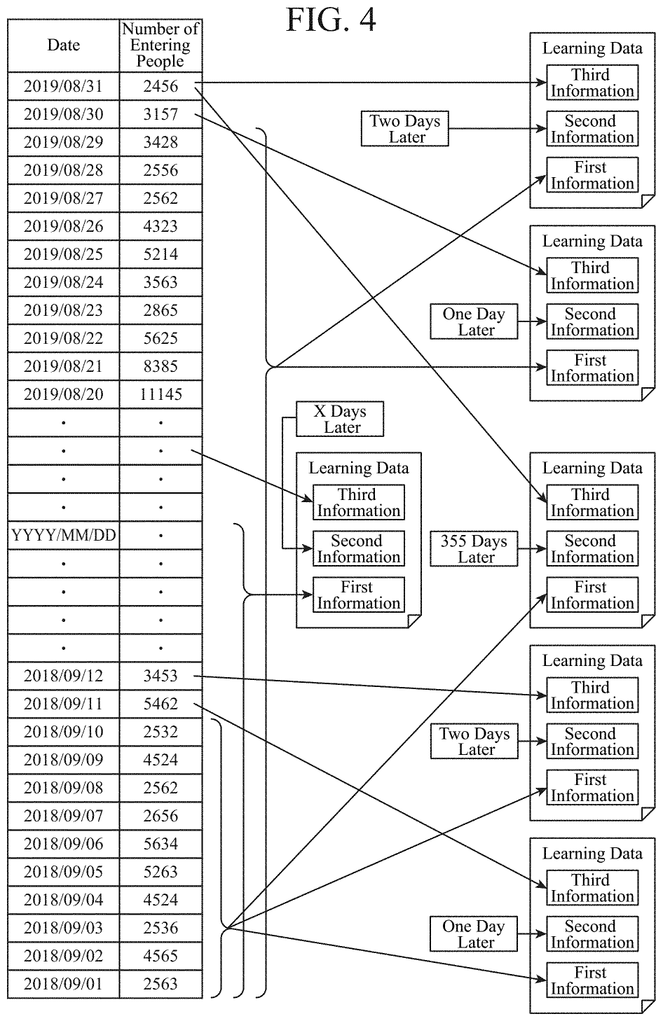

An example of a method of generating a plurality of pieces of learning data by the original time-series data acquiring unit 103, the virtual current date and time determining unit 104, the time-series data segmenting unit 105, the prediction period determining unit 106, the observation value acquiring unit 107, and the learning data generating unit 108 will be described with reference to FIG. 4.

FIG. 4 is a diagram illustrating an example of the original time-series data, the prediction period, the first information, the second information, the third information, and the learning data.

As an example, the original time-series data illustrated in FIG. 4 is a diagram illustrating a part of time-series data in which the number of entering people for 365 days from Sep. 1, 2018 to Aug. 31, 2019 of a certain theme park is indicated as an observation value for each day.

The original time-series data acquiring unit 103 acquires time-series data. In the following description, the time-series data acquired by the original time-series data acquiring unit 103 is referred to as original time-series data.

Specifically, for example, upon receiving the operation information output by the operation receiving unit 102, the original time-series data acquiring unit 103 reads the time-series data indicated by the operation information from the storage device 10 to acquire the time-series data as the original time-series data.

The original time-series data includes observation values in time series.

Specifically, for example, the original time-series data includes a plurality of information sets in which date and time information indicating a time point such as the time, date, week, month, or year when the observation value is obtained is associated with the observation value at the time point such as the time, date, week, month, or year indicated by the date and time information.

The original time-series data acquiring unit 103 acquires, for example, the original time-series data illustrated in FIG. 4 from the storage device 10.

The virtual current date and time determining unit 104 determines one or a plurality of virtual current dates and times, which are virtually determined current dates and times, from among periods corresponding to the original time-series data acquired by the original time-series data acquiring unit 103.

Specifically, for example, the period corresponding to the original time-series data is a period from the most far past time point to the time point closest to the actual current date and time at the time point indicated by the date and time information included in the original time-series data. The period corresponding to the original time-series data may be a partial period of the period included in the period from the most far past time point to the time point closest to the actual current date and time at the time point indicated by the date and time information included in the original time-series data.

For example, the virtual current date and time determining unit 104 automatically determines the virtual current date and time in accordance with a predetermined algorithm. The virtual current date and time determining unit 104 may receive the operation information output from the operation receiving unit 102 and determine the virtual current date and time on the basis of information indicating a time point that the operation information indicates.

For example, the virtual current date and time determining unit 104 determines any one or a plurality of dates among dates from Sep. 10, 2018 to Aug. 29, 2019 as the virtual current date and time on the basis of the original time-series data illustrated in FIG. 4. In the following description, it is assumed that the virtual current date and time determining unit 104 determines all dates from Sep. 10, 2018 to Aug. 29, 2019 as the virtual current date and time on the basis of the original time-series data illustrated in FIG. 4.

For each of one or a plurality of virtual current dates and times determined by the virtual current date and time determining unit 104, the time-series data segmenting unit 105 segments, as time-series data that serves as a basis of the first information, original time-series data corresponding to a period before the virtual current date and time in the original time-series data acquired by the original time-series data acquiring unit 103.

For example, for each of one or a plurality of virtual current dates and times determined by the virtual current date and time determining unit 104, the time-series data segmenting unit 105 segments, as time-series data, original time-series data corresponding to a period from a most far past time point to the virtual current date and time at a time point indicated by date and time information included in the original time-series data in the original time-series data acquired by the original time-series data acquiring unit 103.

The period in which the time-series data segmenting unit 105 segments the time-series data from the original time-series data is not limited to the period from the most far past time point to the virtual current date and time at the time point indicated by the date and time information included in the time-series data. For each of one or a plurality of virtual current dates and times determined by the virtual current date and time determining unit 104, the time-series data segmenting unit 105 may segment, as time-series data, original time-series data corresponding to a partial period of the period from the most far past time point to the virtual current date and time at a time point indicated by the date and time information included in the time-series data.

For example, for each of one or a plurality of virtual current dates and times determined by the virtual current date and time determining unit 104, the time-series data segmenting unit 105 segments, as time-series data, original time-series data corresponding to a period from a time point a predetermined period before the virtual current date and time to the virtual current date and time.

Furthermore, for example, for each of one or a plurality of virtual current dates and times determined by the virtual current date and time determining unit 104, the time-series data segmenting unit 105 may segment, as time-series data, original time-series data corresponding to a predetermined number of observation values closest to the virtual current date and time in the original time-series data before the virtual current date and time.

The method by which the time-series data segmenting unit 105 segments time-series data from the original time-series data is not limited to the above-described method.

For example, on the basis of the original time-series data illustrated in FIG. 4, the time-series data segmenting unit 105 segments, for each date from Sep. 10, 2018 to Aug. 29, 2019, which is the virtual current date and time determined by the virtual current date and time determining unit 104, original time-series data before the virtual current date and time in the original time-series data, as time-series data that serves as a basis of the first information.

More specifically, for example, in a case of Aug. 29, 2019 which is the virtual current date and time, the time-series data segmenting unit 105 segments the original time-series data from Sep. 1, 2018 to Aug. 29, 2019 in the original time-series data as the time-series data that serves as a basis of the first information. Furthermore, for example, in a case where the virtual current date and time is Sep. 10, 2018, the time-series data segmenting unit 105 segments the original time-series data from Sep. 1, 2018 to Sep. 10, 2018 in the original time-series data as time-series data that serves as a basis of the first information.

The prediction period determining unit 106 determines, for each of one or a plurality of virtual current dates and times determined by the virtual current date and time determining unit 104, at least two prediction periods that are different from each other and serve as a basis of the second information, the time point after a lapse of the prediction period being included in the period corresponding to the original time-series data.

Specifically, for example, the prediction period is a period from a time point closest to the current date and time in a period corresponding to the time-series data segmented by the time-series data segmenting unit 105.

More specifically, for example, the prediction period is a period from the virtual current date and time in a case where the time point closest to the current date and time in the period corresponding to the time-series data segmented by the time-series data segmenting unit 105, the time point after the lapse of prediction period being included in the period corresponding to the original time-series data, is the virtual current date and time.

Furthermore, the prediction period may be, for example, a period from an occurrence time point of a predetermined event in a period corresponding to the time-series data segmented by the time-series data segmenting unit 105, a time point after a lapse of the prediction period being included in the period corresponding to the original time-series data.

For example, on the basis of the original time-series data illustrated in FIG. 4, the prediction period determining unit 106 determines at least two prediction periods different from each other so that a time point after a lapse of the prediction period is included in a period corresponding to the original time-series data for each date from Sep. 10, 2018, which is the virtual current date and time determined by the virtual current date and time determining unit 104, to Aug. 29, 2019.

More specifically, for example, in a case where the virtual current date and time is Aug. 29, 2019, the prediction period determining unit 106 determines two periods, that is, one day later and two days later, as the prediction periods. Furthermore, for example, in a case where the virtual current date and time is Sep. 10, 2018, the prediction period determining unit 106 determines 355 periods, that is, one day later, two days later, . . . , and 355 days later, as the prediction periods.

The observation value acquiring unit 107 acquires the observation values after the lapse of the prediction period from the original time-series data for each of at least two prediction periods different from each other determined by the prediction period determining unit 106.

Specifically, for example, in a case where the prediction period is a period from a time point closest to the current date and time in the period corresponding to the time-series data segmented by the time-series data segmenting unit 105, the observation value acquiring unit 107 acquires, from the original time-series data, observation values after a lapse of the prediction period from the time point.

Furthermore, for example, in a case where the prediction period is a period from the virtual current date and time, the observation value acquiring unit 107 acquires, from the original time-series data, observation values after the lapse of the prediction period from the virtual current date and time.

Furthermore, for example, in a case where the prediction period is a period from the occurrence time point of a predetermined event in the period corresponding to the time-series data segmented by the time-series data segmenting unit 105, the observation value acquiring unit 107 acquires, from the original time-series data, the observation values after the lapse of the prediction period from the occurrence time point of the event.

The observation value acquiring unit 107 acquires, for each of one or a plurality of virtual current dates and times determined by the virtual current date and time determining unit 104, observation values after the lapse of at least two prediction periods different from each other determined by the prediction period determining unit 106 from the virtual current date and time, as observation values that serve as a basis of the third information from the original time-series data.

For example, in a case where the virtual current date and time is Aug. 29, 2019 on the basis of the original time-series data illustrated in FIG. 4, the observation value acquiring unit 107 acquires the number of entering people on Aug. 30, 2019, which is the observation value at one day later corresponding to the prediction period, and the number of entering people on Aug. 31, 2019, which is the observation value at two days later, from the original time-series data. Furthermore, for example, in a case where the virtual current date and time is Sep. 10, 2018, the observation value acquiring unit 107 acquires, from the original time-series data, the number of entering people on Sep. 11, 2018, which is the observation value at one day later corresponding to the prediction period, the number of entering people on Sep. 12, 2018, which is the observation value at two days later, . . . , and the number of entering people on Aug. 31, 2019, which is the observation value at 355 days later.

The learning data generating unit 108 generates a plurality of pieces of learning data by combining first information based on one of one or a plurality of pieces of time-series data including observation values in time series, segmented by the time-series data segmenting unit 105, second information based on one of a plurality of prediction periods including at least two prediction periods different from each other, determined by the prediction period determining unit 106, and third information based on observation values after a lapse of the prediction period, acquired by the observation value acquiring unit 107.

Specifically, the learning data generating unit 108 generates learning data by combining the first information, the second information, and the third information each corresponding to the combinations of the virtual current date and time determined by the virtual current date and time determining unit 104 and the prediction period determined by the prediction period determining unit 106, thereby generating a plurality of pieces of learning data.

More specifically, for example, in a case where the virtual current date and time is MM DD, YYYY, and the prediction period is X days later, as illustrated in FIG. 4, the learning data generating unit 108 sets, as the first information, time-series data corresponding to a period from a predetermined time point before MM DD, YYYY to MM DD, YYYY, segmented from the original time-series data by the time-series data segmenting unit 105, sets, as the second information, information indicating X days later which is the prediction period, and sets, as the third information, observation values observed X days later from MM DD, YYYY. The learning data generating unit 108 generates learning data obtained by combining the first information, the second information, and the third information, thereby generating a plurality of pieces of learning data.

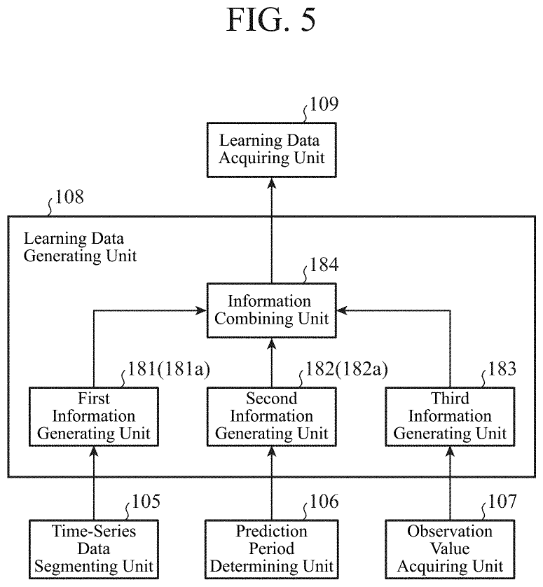

A configuration of a main part of the learning data generating unit 108 according to the first embodiment will be described with reference to FIG. 5.

FIG. 5 is a block diagram illustrating an example of a configuration of a main part of the learning data generating unit 108 according to the first embodiment.

The learning data generating unit 108 includes a first information generating unit 181, a second information generating unit 182, a third information generating unit 183, and an information combining unit 184.

The first information generating unit 181 generates the first information on the basis of one of one or a plurality of pieces of time-series data including observation values in time series, segmented by the time-series data segmenting unit 105.

Specifically, the first information generating unit 181 selects one of a plurality of pieces of time-series data segmented by the time-series data segmenting unit 105, and generates the first information on the basis of the selected time-series data.

More specifically, for example, the first information generating unit 181 segments time-series data corresponding to a predetermined number of observation values in the time-series data segmented from the original time-series data by the time-series data segmenting unit 105, and generates the first information by setting the segmented time-series data as the first information. For example, the learning data generating unit 108 segments time-series data for 10 days closest to the virtual current date and time, that is, time-series data for 10 observation values, in the time-series data segmented from the original time-series data by the time-series data segmenting unit 105, and sets the segmented time-series data as the first information to generate the first information.

Hereinafter, a case where the first information generating unit 181 segments time-series data for 10 days closest to the virtual current date and time, that is, time-series data for 10 observation values, in the time-series data segmented from the original time-series data by the time-series data segmenting unit 105, and sets the segmented time-series data as the first information will be described as an example.

For example, in a case where the virtual current date and time is Aug. 29, 2019 on the basis of the original time-series data illustrated in FIG. 4, the first information generating unit 181 segments time-series data corresponding to a period from Aug. 20, 2019 to Aug. 29, 2019 in time-series data corresponding to a period from Sep. 1, 2018 to Aug. 29, 2019 segmented by the time-series data segmenting unit 105, and sets the segmented time-series data as the first information to generate the first information.

Furthermore, for example, in a case where the virtual current date and time is Sep. 10, 2018 on the basis of the original time-series data illustrated in FIG. 4, the first information generating unit 181 sets, as the first information, time-series data corresponding to a period from Sep. 1, 2018 to Sep. 10, 2018 in time-series data corresponding to a period from Sep. 1, 2018 to Sep. 10, 2018 segmented by the time-series data segmenting unit 105 to generate the first information.

The second information generating unit 182 generates the second information on the basis of one of a plurality of prediction periods including at least two prediction periods different from each other determined by the prediction period determining unit 106.

Specifically, for example, the second information generating unit 182 selects prediction period information indicating one of at least two prediction periods different from each other determined by the prediction period determining unit 106, and sets the selected prediction period information as the second information to generate the second information.

For example, in a case where the virtual current date and time is Aug. 29, 2019 on the basis of the original time-series data illustrated in FIG. 4, the second information generating unit 182 sets, as the second information, prediction period information indicating one day later, which is the prediction period determined by the prediction period determining unit 106, to generate the second information.

Furthermore, for example, in a case where the virtual current date and time is Aug. 29, 2019 on the basis of the original time-series data illustrated in FIG. 4, the second information generating unit 182 sets, as the second information, prediction period information indicating two days later, which is the prediction period determined by the prediction period determining unit 106 to generate the second information.

In addition, in a case where the virtual current date and time is Sep. 10, 2018 on the basis of the original time-series data illustrated in FIG. 4, the second information generating unit 182 sets, as the second information, information indicating that the prediction period is one day later to generate the second information.

In addition, in a case where the virtual current date and time is Sep. 10, 2018 on the basis of the original time-series data illustrated in FIG. 4, the second information generating unit 182 sets, as the second information, information indicating that the prediction period is two days later to generate the second information.

In addition, in a case where the virtual current date and time is Sep. 10, 2018 on the basis of the original time-series data illustrated in FIG. 4, the second information generating unit 182 sets, as the second information, information indicating that the prediction period is 355 days later to generate the second information.

That is, in a case where the virtual current date and time is Sep. 10, 2018 on the basis of the original time-series data illustrated in FIG. 4, the second information generating unit 182 sets, as the second information, information indicating that the prediction period is N (N is a natural number of one or more and 355 or less) days later to generate the second information.

The third information generating unit 183 generates the third information on the basis of the observation values after a lapse of the prediction period acquired by the observation value acquiring unit 107.

Specifically, for example, the third information generating unit 183 sets, as the third information, the observation values after the lapse of the prediction period acquired by the observation value acquiring unit 107 to generate the third information.

For example, in a case where the virtual current date and time is Aug. 29, 2019 and the prediction period is one day later, on the basis of the original time-series data illustrated in FIG. 4, the third information generating unit 183 sets, as the third information, the number of entering people from Aug. 29, 2019, which is the virtual current date and time, to Aug. 30, 2019, which is one day later indicated by the prediction period information, which is the second information, to generate the third information.

Furthermore, for example, on the basis of the original time-series data illustrated in FIG. 4, in a case where the virtual current date and time is Aug. 29, 2019 and the prediction period is two days later, the third information generating unit 183 sets, as the third information, the number of entering people on Aug. 31, 2019, which is two days later indicated by the prediction period information, which is the second information, from Aug. 29, 2019, which is the virtual current date and time to generate the third information.

The information combining unit 184 generates learning data by combining the first information generated by the first information generating unit 181, the second information generated by the second information generating unit 182, and the third information generated by the third information generating unit 183.

For example, in a case where the virtual current date and time is Aug. 29, 2019 and the prediction period is one day later, on the basis of the original time-series data illustrated in FIG. 4, the information combining unit 184 generates one piece of learning data by combining the first information that is the time-series data corresponding to the period from Aug. 20, 2019 to Aug. 29, 2019 generated by the first information generating unit 181, the second information that is the prediction period information indicating one day later that is the prediction period generated by the second information generating unit 182, and the third information that is the number of entering people on Aug. 30, 2019 generated by the third information generating unit 183.

For example, in a case where the virtual current date and time is Aug. 29, 2019 and the prediction period is two days later, on the basis of the original time-series data illustrated in FIG. 4, the information combining unit 184 generates one piece of learning data by combining the first information that is the time-series data corresponding to the period from Aug. 20, 2019 to Aug. 29, 2019 generated by the first information generating unit 181, the second information that is the prediction period information indicating two days later that is the prediction period generated by the second information generating unit 182, and the third information that is the number of entering people on Aug. 31, 2019 generated by the third information generating unit 183.

That is, in a case where the virtual current date and time is Aug. 29, 2019, the learning data generating unit 108 can generate two pieces of learning data in which the prediction periods are one day later and two days later.

Similarly, for example, in a case where the virtual current date and time is Sep. 10, 2018 and the prediction period is N days later, on the basis of the original time-series data illustrated in FIG. 4, the third information generating unit 183 sets, as the third information, the number of entering people corresponding to the date that is N days later indicated by the prediction period information, which is the second information, from Sep. 10, 2018 that is the virtual current date and time to generate the third information.

In a case where the virtual current date and time is Sep. 10, 2018 and the prediction period is N days later, on the basis of the original time-series data illustrated in FIG. 4, the information combining unit 184 generates one piece of learning data by combining the first information that is the time-series data corresponding to the period from Sep. 1, 2018 to Sep. 10, 2018 generated by the first information generating unit 181, the second information that is the prediction period information indicating N days later that is the prediction period generated by the second information generating unit 182, and the third information that is the number of entering people corresponding to the date that is N days later from Sep. 10, 2018 generated by the third information generating unit 183.

That is, in a case where the virtual current date and time is Sep. 10, 2018, the learning data generating unit 108 can generate 355 pieces of learning data corresponding to respective prediction periods from one day later to 355 days later.

Note that the virtual current date and time determining unit 104 has been described as determining the virtual current date and time by setting the dates from Sep. 10, 2018 to Aug. 29, 2019 as the virtual current dates and times on the basis of the original time-series data illustrated in FIG. 4, but the virtual current date and time determining unit 104 may also determine Aug. 30, 2019 as the virtual current date and time.

When the virtual current date and time determining unit 104 determines Aug. 30, 2019 as the virtual current date and time, the prediction period determined by the prediction period determining unit 106 is one day later.

In this case, the observation value acquiring unit 107 acquires the number of entering people on Aug. 31, 2019, which is one day later from Aug. 30, 2019, as the observation value.

That is, in this case, the first information generating unit 181 sets, as the first information, the time-series data corresponding to the period from Aug. 21, 2019 to Aug. 30, 2019 in the time-series data corresponding to the period from Sep. 1, 2018 to Aug. 30, 2019 segmented by the time-series data segmenting unit 105 to generate the first information. In addition, the second information generating unit 182 sets, as the second information, the information indicating that the prediction period is one day later to generate the second information. In addition, the third information generating unit 183 sets, as the third information, the number of entering people on Aug. 31, 2019 that is one day later, which is the prediction period, from Aug. 30, 2019 that is the virtual current date and time to generate the third information. The information combining unit 184 generates one piece of learning data by combining the first information, the second information, and the third information.

The information combining unit 184 repeatedly generates the learning data until generation of learning data is completed in all combinable combination patterns of the first information, the second information, and the third information. The learning data generating unit 108 repeatedly generates the learning data until the information combining unit 184 completes generation of learning data in all combinable combination patterns of the first information, the second information, and the third information to generate a plurality of pieces of learning data.

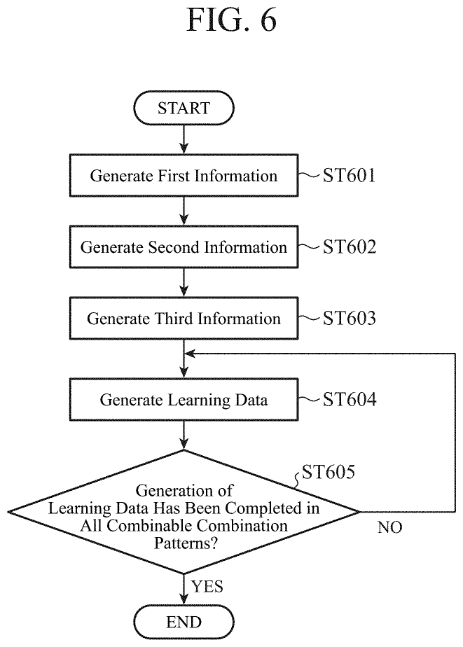

The operation of the learning data generating unit 108 according to the first embodiment will be described with reference to FIG. 6.

FIG. 6 is a flowchart illustrating an example of processing of the learning data generating unit 108 according to the first embodiment.

First, in step ST601, the first information generating unit 181 generates first information.

Next, in step ST602, the second information generating unit 182 generates second information.

Next, in step ST603, the third information generating unit 183 generates third information.

Next, in step ST604, the information combining unit 184 generates learning data.

Next, in step ST605, the information combining unit 184 determines whether or not generation of learning data has been completed in all combinable combination patterns of the first information, the second information, and the third information.

In step ST605, in a case where the information combining unit 184 determines that the generation of learning data has not been completed in all combinable combination patterns, the learning data generating unit 108 repeatedly executes the processing of step ST604 until the information combining unit 184 completes the generation of learning data in all combinable combination patterns.

In step ST605, when the information combining unit 184 determines that the generation of learning data has been completed in all combinable combination patterns, the learning data generating unit 108 ends the processing of the flowchart.

Note that the processing order of processing from step ST601 to step ST603 does not matter as long as the processing is before the processing of step ST604.

With the above configuration, the learning device 100 can generate a plurality of pieces of learning data on the basis of one piece of original time-series data.

Furthermore, the learning device 100 can generate a learned model capable of inferring an observation value that is an inference observation value after a lapse of a designated prediction period, for example, for any prediction period from one day later to 355 days later by learning using the plurality of pieces of learning data generated in this manner.

Note that, in the generation of learned model capable of inferring the observation value that is the inference observation value after the lapse of the prediction period, the learning device 100 may not generate the learned model capable of performing inference for any prediction period from one day later to 355 days later. For example, the learning device 100 may generate a learned model capable of performing inference for any prediction period in a predetermined period, such as a learned model capable of performing inference for any prediction period from one day later to 30 days later, or a learned model capable of performing inference for any prediction period from eight days later to 355 days later.

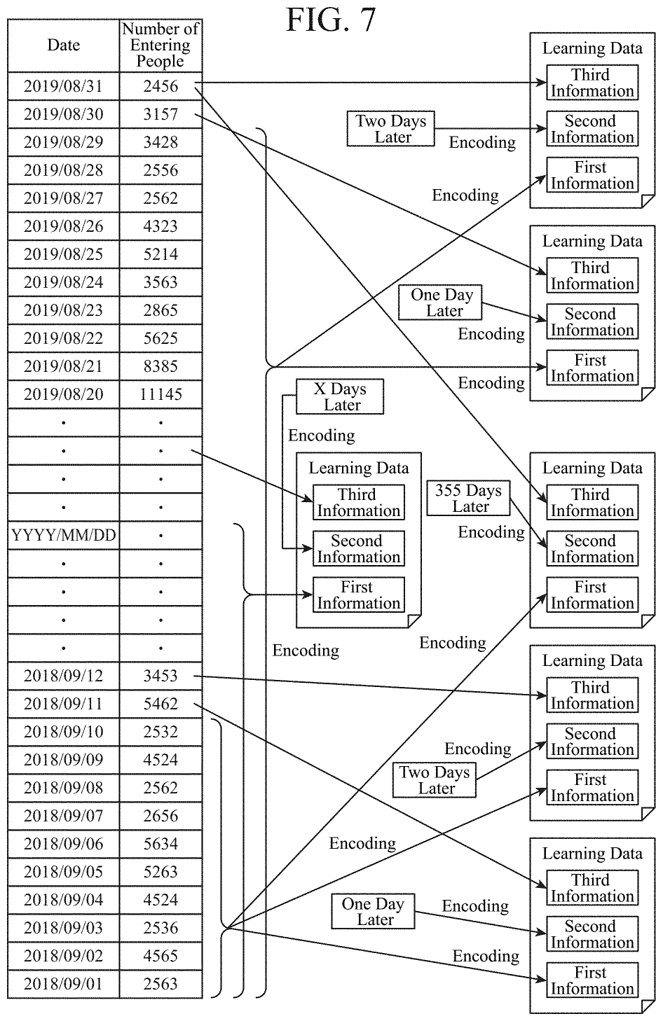

With reference to FIG. 7, a generation method (hereinafter, referred to as a “second method”) different from the above-described generation method (hereinafter, referred to as a “first method”) will be described in a generation method of a plurality of pieces of learning data by the original time-series data acquiring unit 103, the virtual current date and time determining unit 104, the time-series data segmenting unit 105, the prediction period determining unit 106, the observation value acquiring unit 107, and the learning data generating unit 108.

FIG. 7 is a diagram illustrating another example of the original time-series data prediction period, the first information, the second information, the third information, and the learning data.

Similar to the original time-series data shown in FIG. 4, the original time-series data shown in FIG. 7 is a diagram showing, as an example, a part of time-series data showing the number of entering people for 365 days from Sep. 1, 2018 to Aug. 31, 2019 of a certain theme park as an observation value for each day.

In the first method, the learning data generating unit 108 segments time-series data corresponding to a predetermined number of observation values in the time-series data segmented from the original time-series data by the time-series data segmenting unit 105, and sets the segmented time-series data as the first information to generate the first information. Further, in the first method, the learning data generating unit 108 sets, as the second information, the prediction period information indicating the prediction period determined by the prediction period determining unit 106 to generate the second information. Further, in the first method, the learning data generating unit 108 sets, as the third information, the observation values after the lapse of the prediction period acquired by the observation value acquiring unit 107 to generate the third information.

On the other hand, in the second method, the learning data generating unit 108 encodes the time-series data segmented from the original time-series data by the time-series data segmenting unit 105 into vector representation having a predetermined same number of dimensions to generate the first information. Further, in the second method, the learning data generating unit 108 encodes the prediction period information indicating the prediction period determined by the prediction period determining unit 106 into vector representation having a predetermined number of dimensions to generate the second information.

For example, in a case where the virtual current date and time is MM DD, YYYY and the prediction period is X days later, as illustrated in FIG. 7, the learning data generating unit 108 encodes the time-series data corresponding to the period from Sep. 1, 2018 to MM DD, YYYY, which is segmented from the original time-series data by the time-series data segmenting unit 105, into vector representation having a predetermined same number of dimensions to obtain the first information, encodes the information indicating X days later, which is the prediction period, into vector representation having a predetermined same number of dimensions to obtain the second information, and sets the observation values observed after X days later from MM DD, YYYY as the third information.

Note that the processing of each of the original time-series data acquiring unit 103, the virtual current date and time determining unit 104, the time-series data segmenting unit 105, the prediction period determining unit 106, and the observation value acquiring unit 107 in the second method is similar to the processing of each of the original time-series data acquiring unit 103, the virtual current date and time determining unit 104, the time-series data segmenting unit 105, the prediction period determining unit 106, and the observation value acquiring unit 107 in the first method, and thus description thereof is omitted.

More specifically, the learning data generating unit 108 in the second method will be described as including a first information generating unit 181a, a second information generating unit 182a, a third information generating unit 183, and an information combining unit 184.

The configuration of the main part of the learning data generating unit 108 in the second method is merely a configuration in which the first information generating unit 181 and the second information generating unit 182 are changed to the first information generating unit 181a and the second information generating unit 182a in the configuration of the main part of the learning data generating unit 108 in the first method illustrated in FIG. 5, and thus a block diagram illustrating the configuration of the main part of the learning data generating unit 108 in the second method is omitted.

The first information generating unit 181a generates the first information on the basis of one of one or a plurality of pieces of time-series data including observation values in time series, which is segmented by the time-series data segmenting unit 105.

Specifically, the first information generating unit 181a selects one of the plurality of pieces of time-series data segmented by the time-series data segmenting unit 105, and generates the first information on the basis of the selected time-series data.

More specifically, for example, the first information generating unit 181a generates the first information by encoding the time-series data into vector representation having the predetermined same number of dimensions on the basis of the time-series data segmented from the original time-series data by the time-series data segmenting unit 105.

For example, the first information generating unit 181a generates the first information by encoding the time-series data into vector representation having the predetermined same number of dimensions using a summary statistic such as an average value, a median value, a mode value, a maximum value, a minimum value, or a standard deviation of the time-series data obtained by statistically processing the time-series data segmented from the original time-series data by the time-series data segmenting unit 105.

Furthermore, for example, the first information generating unit 181a may generate the first information by performing low rank approximation processing such as singular value decomposition on time-series data segmented from the original time-series data by the time-series data segmenting unit 105 to reduce the number of dimensions of the time-series data, and encoding the time-series data into vector representation having the predetermined same number of dimensions.

Furthermore, for example, the first information generating unit 181a may generate the first information by applying a hash function to time-series data segmented from the original time-series data by the time-series data segmenting unit 105 and encoding the time-series data into vector representation having the predetermined same number of dimensions.

Furthermore, for example, the first information generating unit 181a may generate the first information by inputting time-series data segmented from the original time-series data by the time-series data segmenting unit 105 to a digital filter and encoding the time-series data into vector representation having the predetermined same number of dimensions.

Furthermore, for example, the first information generating unit 181a may generate the first information by inputting time-series data segmented from the original time-series data by the time-series data segmenting unit 105 to a neural network that performs convolution processing or the like and encoding the time-series data into vector representation having the predetermined same number of dimensions.

Note that the first information generating unit 181a may generate the first information by, for example, combining the above-described first information generation methods and encoding the time-series data into vector representation having the predetermined same number of dimensions.

When the virtual current date and time determined by the virtual current date and time determining unit 104 changes, the number of observation values included in the time-series data segmented from the original time-series data by the time-series data segmenting unit 105 varies. Since the learning data generating unit 108 includes the first information generating unit 181a, even when the number of observation values included in the time-series data segmented from the original time-series data by the time-series data segmenting unit 105 varies, the time-series data can be encoded into vector representation having the predetermined same number of dimensions.

The second information generating unit 182a generates the second information on the basis of one of a plurality of prediction periods including at least two prediction periods different from each other determined by the prediction period determining unit 106.

Specifically, for example, the second information generating unit 182a selects prediction period information indicating one of at least two prediction periods different from each other determined by the prediction period determining unit 106, and sets the selected prediction period information as the second information to generate the second information.

More specifically, for example, the second information generating unit 182a generates the second information by encoding the prediction period information indicating the prediction period determined by the prediction period determining unit 106 into vector representation having a predetermined number of dimensions.

For example, the second information generating unit 182a generates the second information by encoding prediction period information represented by any unit such as a time difference between a time point after the lapse of the prediction period determined by the prediction period determining unit 106 and the current date and time determined by the virtual current date and time determining unit 104 into vector representation having a predetermined number of dimensions.

Furthermore, for example, the second information generating unit 182a may generate the second information by encoding prediction period information represented by any unit such as a time difference between a time point after the lapse of the prediction period determined by the prediction period determining unit 106 and an occurrence time point of a predetermined event in a period corresponding to the time-series data segmented from the original time-series data by the time-series data segmenting unit 105 into vector representation having a predetermined number of dimensions.

Furthermore, for example, the second information generating unit 182a may generate the second information by encoding prediction period information represented by any unit such as a year, a month, a week, a day of week, a holiday, or a specific date, which is a time point after the lapse of the prediction period determined by the prediction period determining unit 106, into vector representation having a predetermined number of dimensions.

Furthermore, for example, the second information generating unit 182a may generate the second information by encoding prediction period information represented by any unit such as hour, minute, second, or time period, which is a time point after the lapse of the prediction period determined by the prediction period determining unit 106, into vector representation having a predetermined number of dimensions.

Note that the second information generating unit 182a may generate the second information by, for example, converting information encoded into vector representation having a predetermined number of dimensions by the above-described generation method using a predetermined function such as a logarithmic function or a trigonometric function, and setting the converted information as the second information.

More specifically, for example, the second information generating unit 182a may generate the second information by taking a logarithm of T, which is a positive real number such as log (T), to convert T into a value indicating the entire real number, and encoding the converted value, where T is a time difference between a time point after a lapse of the prediction period determined by the prediction period determining unit 106 and the current date and time determined by the virtual current date and time determining unit 104.

Furthermore, for example, the second information generating unit 182a may generate the second information by converting T into a periodic value by applying a trigonometric function to T, such as cos (2nT/P) or sin (2nT/P), using a predetermined period P and any natural number n, and encoding the converted value.

Furthermore, for example, the second information generating unit 182a may generate the second information by converting T into periodic information by obtaining a quotient and a remainder obtained by dividing T by P and encoding the quotient and the remainder.

As described above, since the learning data generating unit 108 includes the second information generating unit 182a, the prediction period information represented by any unit can be encoded into vector representation having a predetermined number of dimensions.

In addition, the observation interval of the observation values included in the time-series data segmented from the original time-series data by the time-series data segmenting unit 105 may be different depending on the original time-series data. Therefore, the second information generating unit 182a, when generating the second information by encoding prediction period information represented by any unit into vector representation having a predetermined number of dimensions, preferably encodes the prediction period information into vector representation having the same number of dimensions regardless of the prediction period information.

Since the operation of the learning data generating unit 108 in the second method is similar to the operation of the learning data generating unit 108 in the first method illustrated in FIG. 6, the description of the processing of the learning data generating unit 108 in the second method is omitted.

With the above configuration, the learning device 100 can generate a plurality of pieces of learning data on the basis of one piece of original time-series data.

The inference system 1 may include a learning data generation device (not illustrated) that generates a plurality of pieces of learning data from the original time-series data.

The learning data generation device includes the original time-series data acquiring unit 103, the virtual current date and time determining unit 104, the time-series data segmenting unit 105, the prediction period determining unit 106, the observation value acquiring unit 107, and the learning data generating unit 108.

Since the inference system 1 includes the learning data generation device, the learning data acquiring unit 109 in the learning device 100 can acquire the plurality of pieces of learning data generated by the learning data generation device directly from the learning data generation device or via the storage device 10 or the like.

Note that each of the functions of the original time-series data acquiring unit 103, the virtual current date and time determining unit 104, the time-series data segmenting unit 105, the prediction period determining unit 106, the observation value acquiring unit 107, and the learning data generating unit 108 included in the learning data generation device may be implemented by the processor 301 and the memory 302 in the hardware configuration illustrated as an example in FIGS. 3A and 3B, or may be implemented by the processing circuit 303.

The learning unit 110 performs learning using a plurality of pieces of learning data acquired by the learning data acquiring unit 109, with information obtained by combining the first information and the second information in the learning data as an explanatory variable and the third information as a response variable. The learning unit 110 generates a learned model capable of inferring the inference observation value after the lapse of the designated prediction period by the learning.

More specifically, when performing learning with the third information as a response variable, the learning unit 110 generates a learned model capable of inferring an inference observation value after a lapse of a designated prediction period by performing supervised machine learning using the response variable as teacher data.

The learning unit 110 performs learning by using a plurality of pieces of learning data in which one piece of learning data is a combination of first information based on one of one or a plurality of pieces of time-series data including observation values in time series, second information based on one of a plurality of prediction periods including at least two prediction periods different from each other, and third information based on observation values after a lapse of the prediction period. Therefore, in a case where a designated prediction period in inference of an inference observation value corresponds to a prediction period that serves as a basis of the second information, the learned model generated by the learning unit 110 can infer an inference observation value after a lapse of the designated prediction period by performing inference only once.

Furthermore, as described above, the learning unit 110 learns information obtained by combining the first information and the second information in the learning data as an explanatory variable. Therefore, by using the information obtained by combining the first information and the second information both encoded into vector representation having the predetermined number of dimensions, which is generated by the above-described second method, as an explanatory variable, the learning unit 110 can perform learning even when the time-series data including the observation values in time series serving as the basis of the first information is time-series data including any number of observation values, or even when the prediction period information indicating at least two prediction periods different from each other serving as the basis of the second information is prediction period information represented by any unit.

Note that the learning in the learning unit 110 is performed by any learning algorithm depending on the learned model generated by the learning unit 110. For example, in a case where the learned model to be generated is a learned model configured by a neural network, learning in the learning unit 110 is performed by a learning algorithm such as a stochastic gradient descent method. Furthermore, for example, a method such as cross verification may be applied to the learning in the learning unit 110 in order to appropriately set the hyperparameter used for the learned model.

Furthermore, the inference method by the learned model generated by the learning unit 110 is any inference method such as a neighborhood method, a support vector machine, a decision tree, a random forest, a gradient boosting tree, a Gaussian process regression, or a neural network.

The model output unit 111 outputs the learned model generated by the learning unit 110 as model information. The model output unit 111 outputs the information to, for example, the inference device 200 or the storage device 10.

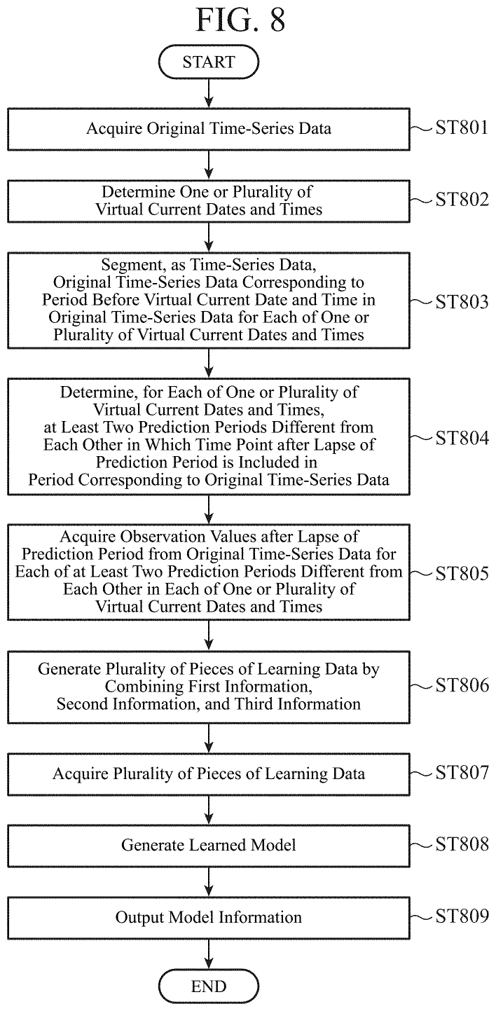

The operation of the learning device 100 according to the first embodiment will be described with reference to FIG. 8.

FIG. 8 is a flowchart illustrating an example of processing of the learning device 100 according to the first embodiment.

First, in step ST801, the original time-series data acquiring unit 103 acquires original time-series data.

Next, in step ST802, the virtual current date and time determining unit 104 determines one or a plurality of virtual current dates and times.

Next, in step ST803, the time-series data segmenting unit 105 segments, as time-series data, original time-series data corresponding to a period before the virtual current date and time in the original time-series data for each of one or a plurality of virtual current dates and times.

Next, in step ST804, the prediction period determining unit 106 determines, for each of one or a plurality of virtual current dates and times, at least two prediction periods different from each other in which a time point after a lapse of the prediction period is included in a period corresponding to the original time-series data.

Next, in step ST805, the observation value acquiring unit 107 acquires observation values after the lapse of the prediction period from the original time-series data for each of at least two prediction periods different from each other in each of one or a plurality of virtual current dates and times.

Next, in step ST806, the learning data generating unit 108 generates a plurality of pieces of learning data by combining the first information, the second information, and the third information, one of one or a plurality of pieces of time-series data including observation values in time series segmented by the time-series data segmenting unit 105 being the first information, prediction period information indicating one of a plurality of prediction periods including at least two prediction periods different from each other beings the second information, and the observation values after the lapse of the prediction period being the third information.

Next, in step ST807, the learning data acquiring unit 109 acquires a plurality of pieces of learning data.

Next, in step ST808, the learning unit 110 performs learning using a plurality of pieces of learning data and generates a learned model.

Next, in step ST809, the model output unit 111 outputs the learned model as model information.

After the processing of step ST809, the learning device 100 ends the processing of the flowchart.

As described above, the learning device 100 includes: the learning data acquiring unit 109 to acquire a plurality of pieces of learning data in which one piece of learning data is a combination of first information based on one of one or a plurality of pieces of time-series data including observation values in time series, second information based on one of a plurality of prediction periods including at least two prediction periods different from each other, and third information based on observation values after a lapse of the prediction period; and the learning unit 110 to perform learning using the plurality of pieces of learning data acquired by the learning data acquiring unit 109 using information obtained by combining the first information and the second information in the learning data as an explanatory variable and using the third information as a response variable, and generates a learned model capable of inferring an inference observation value after a lapse of a designated prediction period.

With such a configuration, the learning device 100 can enable inference of an observation value having high inference accuracy with less inference error in inference of any future observation value.

Furthermore, in addition to the above-described configuration, the learning device 100 includes: the virtual current date and time determining unit 104 to determine one or a plurality of virtual current dates and times, which are virtually determined current dates and times, from a period corresponding to one piece of original time-series data including observation values in time series; the time-series data segmenting unit 105 to segment, for each of one or a plurality of the virtual current dates and times determined by the virtual current date and time determining unit 104, the original time-series data corresponding to a period before the virtual current date and time in the original time-series data as time-series data including the observation values in time series that serve as a basis of first information; the prediction period determining unit 106 to determine, for each of one or a plurality of the virtual current dates and times determined by the virtual current date and time determining unit 104, at least two prediction periods that are different from each other and serve as a basis of second information, a time point after a lapse of a prediction period being included in a period corresponding to the original time-series data; the observation value acquiring unit 107 to acquire, for each of at least the two prediction periods different from each other determined by the prediction period determining unit 106, the observation values after the lapse of the prediction period that serve as a basis of third information, from the original time-series data; and the learning data generating unit 108 to generate a plurality of pieces of learning data by combining the first information based on one of one or a plurality of pieces of the time-series data including the observation values in time series segmented by the time-series data segmenting unit 105, the second information based on one of a plurality of the prediction periods including at least the two prediction periods different from each other determined by the prediction period determining unit 106, and the third information based on the observation values after the lapse of the prediction period acquired by the observation value acquiring unit 107, and the learning data acquiring unit 109 is configured to acquire a plurality of pieces of learning data generated by the learning data generating unit 108.

With this configuration, the learning device 100 can generate a plurality of pieces of learning data on the basis of one piece of original time-series data.

Furthermore, with such a configuration, the learning device 100 can generate a learned model capable of inferring an observation value, which is an inference observation value after the lapse of the prediction period, with high accuracy for any designated prediction period by performing learning using the plurality of pieces of learning data generated in this manner.

Furthermore, in the above-described configuration, the learning device 100 is configured so that the prediction period serving as a basis of the second information in the learning data is a period from a time point closest to the current date and time in the period corresponding to the time-series data serving as a basis of the first information in the learning data, and the third information in the learning data is information based on an observation value after the lapse of the prediction period from the time point.

With such a configuration, the learning device 100 can enable inference of an observation value having high inference accuracy with less inference error in inference of any future observation value.

More specifically, with such a configuration, the learning device 100 can generate a learned model capable of inferring an observation value, which is an inference observation value after the lapse of the prediction period from a time point closest to the current date and time in the period corresponding to the time-series data, with high accuracy in the inference of any future observation value.

Furthermore, in the above-described configuration, the learning device 100 is configured so that the prediction period serving as a basis of the second information in the learning data is a period from an occurrence time point of a predetermined event in a period corresponding to the time-series data serving as a basis of the first information in the learning data, and the third information in the learning data is information based on an observation value after the lapse of the prediction period from the occurrence time point of the event.

With such a configuration, the learning device 100 can enable inference of an observation value having high inference accuracy with less inference error in inference of any future observation value.

More specifically, with such a configuration, the learning device 100 can generate a learned model capable of inferring an observation value, which is an inference observation value after the lapse of the prediction period from the occurrence time point of the predetermined event in the period corresponding to the time-series data, with high accuracy in the inference of any future observation value.

Furthermore, in the above-described configuration, the learning device 100 is configured so that the second information is information obtained by encoding prediction period information capable of specifying a prediction period into vector representation having a predetermined number of dimensions.

With this configuration, the learning device 100 can encode the prediction period information represented by any unit into vector representation having a predetermined number of dimensions.

More specifically, with such a configuration, the learning device 100 can perform learning even when the prediction period information indicating at least two prediction periods different from each other serving as the basis of the second information is prediction period information represented by any unit.

Furthermore, in the above-described configuration, the learning device 100 is configured so that each of all pieces of the prediction period information represented by any unit is information encoded into vector representation having the predetermined same number of dimensions.

With this configuration, the learning device 100 can encode the prediction period information represented by any unit into vector representation having a predetermined number of dimensions.

More specifically, with such a configuration, the learning device 100 can perform learning even when the prediction period information indicating at least two prediction periods different from each other serving as the basis of the second information is prediction period information represented by any unit.

Furthermore, in the above-described configuration, the learning device 100 is configured so that the first information is information encoded into vector representation having the predetermined same number of dimensions in all pieces of the time-series data serving as the basis of the first information.

With this configuration, even in a case where the number of observation values included in the time-series data segmented from the original time-series data by the time-series data segmenting unit 105 varies, the learning device 100 can encode the time-series data into vector representation having the predetermined same number of dimensions.

More specifically, with such a configuration, the learning device 100 can perform learning even when the time-series data including the observation values in time series serving as the basis of the first information is time-series data including any number of observation values.

Furthermore, in the above-described configuration, the learning device 100 is configured so that the learning unit 110 learns, as an explanatory variable, information based on vector representation obtained by connecting first information encoded into vector representation and second information encoded into vector representation.

With such a configuration, the learning device 100 can perform learning even when the time-series data including the observation values in time series serving as the basis of the first information is the time-series data including any number of observation values, and even when the prediction period information indicating at least two prediction periods different from each other serving as the basis of the second information is the prediction period information represented by any unit.

Furthermore, as described above, the learning data generation apparatus includes: the virtual current date and time determining unit 104 to determine one or a plurality of virtual current dates and times, which are virtually determined current dates and times, from a period corresponding to one piece of original time-series data including observation values in time series; the time-series data segmenting unit 105 to segment, for each of one or a plurality of the virtual current dates and times determined by the virtual current date and time determining unit 104, the original time-series data corresponding to a period before the virtual current date and time in the original time-series data as time-series data including the observation values in time series that serve as a basis of first information; the prediction period determining unit 106 to determine, for each of one or a plurality of the virtual current dates and times determined by the virtual current date and time determining unit 104, at least two prediction periods that are different from each other and serve as a basis of second information, a time point after a lapse of a prediction period being included in a period corresponding to the original time-series data; the observation value acquiring unit 107 to acquire, for each of at least the two prediction periods different from each other determined by the prediction period determining unit 106, the observation values after the lapse of the prediction period that serve as a basis of third information, from the original time-series data; and the learning data generating unit 108 to generate a plurality of pieces of learning data by combining the first information based on one of one or a plurality of pieces of the time-series data including the observation values in time series segmented by the time-series data segmenting unit 105, the second information based on one of a plurality of the prediction periods including at least the two prediction periods different from each other determined by the prediction period determining unit 106, and the third information based on the observation values after the lapse of the prediction period acquired by the observation value acquiring unit 107.

With such a configuration, the learning data generation device can generate a plurality of pieces of learning data on the basis of one piece of original time-series data.

Furthermore, with such a configuration, the learning data generation device can provide the plurality of pieces of learning data generated in this manner to the learning device 100 that generates the learned model. The learning device 100 can generate a learned model capable of inferring an observation value, which is an inference observation value after a lapse of a prediction period, with high accuracy for any designated prediction period by performing learning using a plurality of pieces of learning data provided from the learning data generation device.

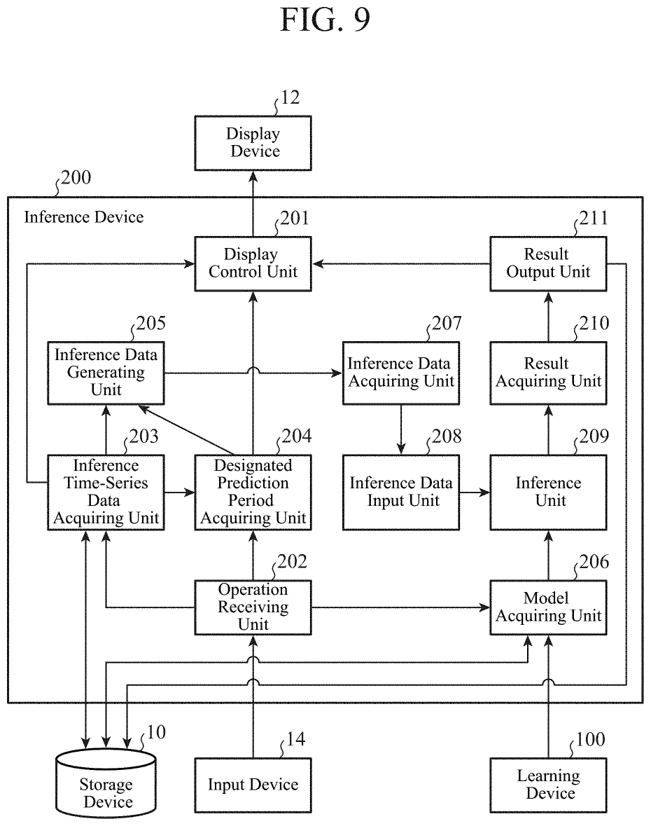

The inference device 200 according to the first embodiment will be described with reference to FIGS. 9 to 11.

FIG. 9 is a block diagram showing an example of a configuration of a main part of the inference device 200 according to the first embodiment.

The inference device 200 includes a display control unit 201, an operation receiving unit 202, an inference time-series data acquiring unit 203, a model acquiring unit 206, a designated prediction period acquiring unit 204, an inference data generating unit 205, an inference data acquiring unit 207, an inference data input unit 208, an inference unit 209, a result acquiring unit 210, and a result output unit 211.

Note that each of the functions of the display control unit 201, the operation receiving unit 202, the inference time-series data acquiring unit 203, the model acquiring unit 206, the designated prediction period acquiring unit 204, the inference data generating unit 205, the inference data acquiring unit 207, the inference data input unit 208, the inference unit 209, the result acquiring unit 210, and the result output unit 211 included in the inference device 200 may be implemented by the processor 301 and the memory 302 in the hardware configuration illustrated as an example in FIGS. 3A and 3B, or may be implemented by the processing circuit 303.

The display control unit 201 generates an image signal corresponding to an image to be displayed on the display device 12, and outputs the generated image signal to the display device 12. The image to be displayed on the display device 12 is an image indicating a list of time-series data stored in the storage device 10, a list of model information, or the like.

The operation receiving unit 202 receives the operation signal output from the input device 14, and outputs operation information indicating a user's input operation corresponding to the operation signal to the inference time-series data acquiring unit 203, the designated prediction period acquiring unit 204, the model acquiring unit 206, or the like.

The operation information output from the operation receiving unit 202 is information indicating time-series data, model information, or the like designated by a user's input operation in the time-series data stored in the storage device 10.

The inference data acquiring unit 207 acquires inference data obtained by combining fourth information based on time-series data including observation values in time series and fifth information capable of specifying designated prediction period of the prediction target.

Specifically, for example, inference data generated by the inference data generating unit 205 is acquired. The inference data generating unit 205 generates inference data using the information acquired by the inference time-series data acquiring unit 203 and the designated prediction period acquiring unit 204.

Note that the inference data acquiring unit 207 may acquire inference data by reading inference data prepared in advance from the storage device 10. In a case where the inference data acquiring unit 207 acquires the inference data by reading the inference data prepared in advance from the storage device 10, the inference time-series data acquiring unit 203, the designated prediction period acquiring unit 204, and the inference data generating unit 205 are not essential components.

The inference time-series data acquiring unit 203 acquires time-series data. In the following description, the time-series data acquired by the inference time-series data acquiring unit 203 is referred to as inference time-series data.

Specifically, for example, the inference time-series data acquiring unit 203 receives the operation information output from the operation receiving unit 202 and reads the time-series data indicated by the operation information from the storage device 10 to acquire the time-series data as the inference time-series data.

The designated prediction period acquiring unit 204 acquires designated prediction period information indicating the designated prediction period of the prediction target.

Specifically, for example, the designated prediction period that can be specified by the fifth information in the inference data is a period from a time point closest to the current date and time in a period corresponding to the inference time-series data serving as a basis of the fourth information in the inference data.

In addition, for example, the designated prediction period that can be specified by the fifth information in the inference data is a period from an occurrence time point of a predetermined event in a period corresponding to the inference time-series data serving as a basis of the fourth information in the inference data.

For example, the designated prediction period acquiring unit 204 receives the operation information output from the operation receiving unit 202, and converts the designated prediction period of the prediction target indicated by the operation information into the designated prediction period information to acquire the designated prediction period information.

The inference data generating unit 205 generates inference data obtained by combining the fourth information based on the inference time-series data acquired by the inference time-series data acquiring unit 203 and the fifth information capable of specifying the designated prediction period of the prediction target indicated by the designated prediction period information based on the designated prediction period information acquired by the designated prediction period acquiring unit 204.

Specifically, for example, the inference data generating unit 205 segments inference time-series data corresponding to a predetermined number of observation values closest to the current date and time in the inference time-series data acquired by the inference time-series data acquiring unit 203, and sets the segmented inference time-series data as the fourth information. In addition, the inference data generating unit 205 sets the designated prediction period information acquired by the designated prediction period acquiring unit 204 as the fifth information. The inference data generating unit 205 generates inference data by combining the fourth information and the fifth information. In a case where the inference data generating unit 205 generates the inference data by such a method, the designated prediction period that can be specified by the fifth information in the inference data is a period from a time point closest to the current date and time in a period corresponding to the inference time-series data serving as a basis of the fourth information in the inference data.

Furthermore, for example, the inference data generating unit 205 may segment inference time-series data corresponding to a predetermined number of observation values closest to the current date and time in the inference time-series data before the occurrence time point of the predetermined event in the inference time-series data acquired by the inference time-series data acquiring unit 203, and set the segmented inference time-series data as the fourth information. The inference data generating unit 205 sets the designated prediction period information acquired by the designated prediction period acquiring unit 204 as the fifth information. The inference data generating unit 205 generates inference data by combining the fourth information and the fifth information. In a case where the inference data generating unit 205 generates the inference data by such a method, the designated prediction period that can be specified by the fifth information in the inference data is a period from an occurrence time point of a predetermined event in a period corresponding to the inference time-series data serving as a basis of the fourth information in the inference data.

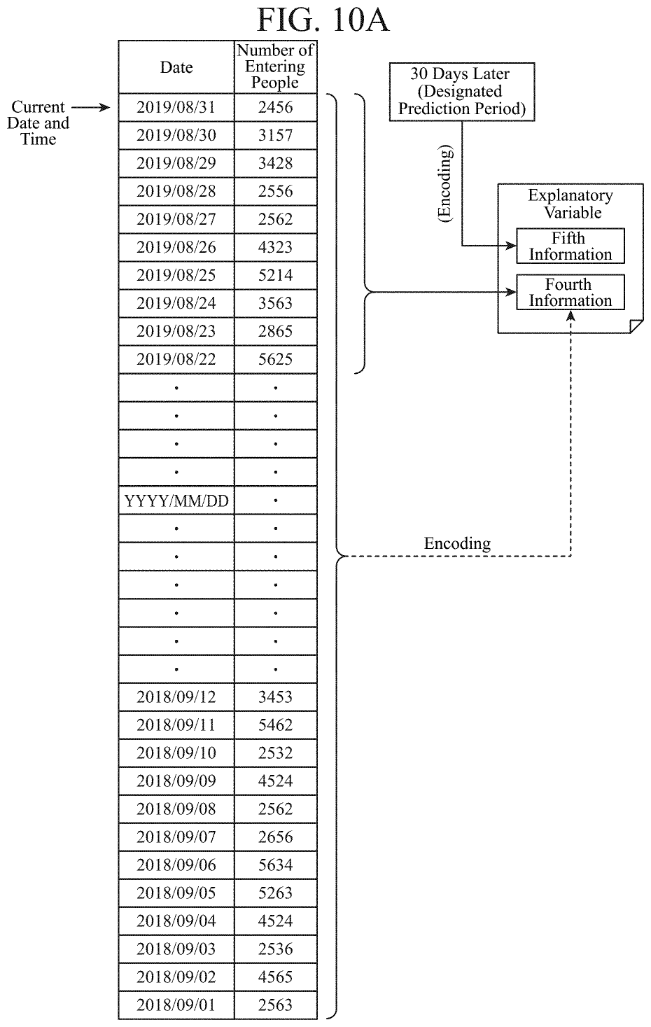

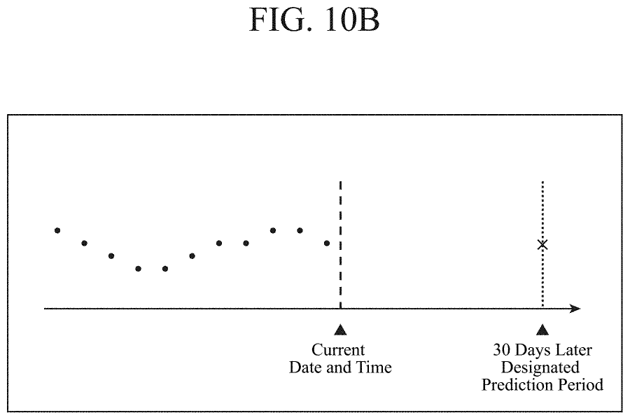

An example of a specific generation method of inference data by the inference time-series data acquiring unit 203, the designated prediction period acquiring unit 204, and the inference data generating unit 205 will be described with reference to FIG. 10A.

FIG. 10A is a diagram illustrating an example of inference time-series data, a designated prediction period, fourth information, fifth information, and an explanatory variable.

Similarly to the original time-series data illustrated in FIG. 4, the inference time-series data illustrated in FIG. 10A is a diagram illustrating a part of the inference time-series data in which the number of entering people for 365 days from Sep. 1, 2018 to Aug. 31, 2019 of a certain theme park is indicated as an observation value for each day, as an example.

The inference time-series data acquiring unit 203 acquires the inference time-series data illustrated in FIG. 10A from the storage device 10.

On the basis of the inference data illustrated in FIG. 10A, the inference data generating unit 205 segments the inference time-series data corresponding to the period from Aug. 22, 2019 to Aug. 31, 2019 so that the number of observation values is 10, which is a predetermined number, in the inference time-series data corresponding to the period from Sep. 1, 2018 to Aug. 31, 2019, for example. The inference data generating unit 205 sets the inference time-series data corresponding to the segmented period from Aug. 22, 2019 to Aug. 31, 2019 as the fourth information.

In addition, as illustrated in FIG. 10A, the inference data generating unit 205 sets, for example, designated prediction period information indicating that the designated prediction period of the prediction target is 30 days later as the fifth information.

For example, as indicated by a broken line in FIG. 10A, the inference data generating unit 205 may set, as the fourth information, information obtained by encoding the inference time-series data acquired by the inference time-series data acquiring unit 203 into vector representation having the predetermined same number of dimensions. The method by which the inference data generating unit 205 encodes the inference time-series data into vector representation having the predetermined same number of dimensions is similar to the method of encoding the time-series data into vector representation having the predetermined same number of dimensions when the first information generating unit 181a in the learning device 100 generates the first information, and thus, description thereof is omitted.

For example, as illustrated by description in parentheses in FIG. 10A, the inference data generating unit 205 may set, as the fifth information, information obtained by encoding the designated prediction period information capable of specifying the designated prediction period into vector representation having a predetermined number of dimensions. The method by which the inference data generating unit 205 encodes the designated prediction period information capable of specifying the designated prediction period into vector representation having the predetermined number of dimensions is similar to the method by which the second information generating unit 182a in the learning device 100 encodes the prediction period information into vector representation having the predetermined number of dimensions when generating the second information, and thus the description thereof will be omitted.

Note that the fifth information is preferably information encoded into vector representation having the predetermined same number of dimensions in all pieces of the designated prediction period information represented by any unit.

The model acquiring unit 206 acquires model information.

Specifically, for example, the model acquiring unit 206 receives the operation information output from the operation receiving unit 202, and reads the model information indicated by the operation information from the storage device 10 to acquire the model information.

The learned model indicated by the model information acquired by the model acquiring unit 206 is a learned model corresponding to a learning result by machine learning using a plurality of pieces of learning data in which information obtained by combining first information and second information in learning data obtained by combining the first information based on one of one or a plurality of pieces of time-series data including observation values in time series, the second information based on one of a plurality of prediction periods including at least two prediction periods different from each other, and third information based on observation values after a lapse of the prediction period is used as an explanatory variable, and the third information is used as a response variable.

Specifically, for example, the model information acquired by the model acquiring unit 206 is the model information output from the learning device 100. The model acquiring unit 206 acquires the model information output from the learning device 100 directly from the learning device 100 or via the storage device 10.

FIG. 9 illustrates a case where the model acquiring unit 206 directly acquires the model information output by the learning device 100 from the learning device 100.

The inference unit 209 uses the learned model indicated by the model information acquired by the model acquiring unit 206 to infer the inference observation value after the lapse of the designated prediction period.

Note that the inference unit 209 that infers the inference observation value after the lapse of the designated prediction period designated using the learned model may be provided in the inference device 200 or may be provided in an external device (not illustrated) connected to the inference device 200.

The inference data input unit 208 inputs the inference data acquired by the inference data acquiring unit 207 as an explanatory variable to a learned model corresponding to a learning result by machine learning.

More specifically, the inference data input unit 208 outputs the inference data to the inference unit 209, and causes the inference unit 209 to input the inference data to the learned model.

Since the inference data obtained by combining the fourth information and the fifth information is input as an explanatory variable to the learned model, the inference data generating unit 205 generates the inference data obtained by combining the fourth information and the fifth information, both of which are encoded into vector representation having a predetermined number of dimensions, so that the learned model can receive, as an explanatory variable, the inference data obtained by combining the fourth information and the fifth information even if the inference time-series data including the observation values in time series serving as the basis of the fourth information is time-series data including any number of observation values, or even if the designated prediction period information indicating the designated prediction period serving as the basis of the fifth information is information represented by any unit.

The result acquiring unit 210 acquires the inference observation value after a lapse of the designated prediction period output as the inference result by the learned model.

More specifically, the result acquiring unit 210 acquires the inference observation value after the lapse of the designated prediction period, which is output as the inference result by the learned model, from the inference unit 209 or an external device including the inference unit 209.

The result output unit 211 outputs the inference observation value acquired by the result acquiring unit 210.

Specifically, for example, the result output unit 211 outputs the inference observation value acquired by the result acquiring unit 210 via the display control unit 201. The display control unit 201, upon receiving the inference observation value from the result output unit 211, generates an image signal corresponding to an image indicating the inference observation value, outputs the image signal to the display device 12, and causes the display device 12 to display the image indicating the inference observation value.

In addition, for example, the result output unit 211 may output the inference observation value acquired by the result acquiring unit 210 to the storage device 10 and cause the storage device 10 to store the inference observation value.

In a case where the learned model generated by the learning device 100 is a learned model capable of inferring an observation value that is an inference observation value after a lapse of a prediction period for any prediction period from one day later to 355 days later learned on the basis of the original time-series data illustrated in FIG. 4, the designated prediction period indicated by the designated prediction period information acquired by the designated prediction period acquiring unit 204 is, for example, any period from one day later to 355 days later.

In a case where the designated prediction period indicated by the designated prediction period information corresponds to any of the plurality of prediction periods in which the inference observation value after the lapse of the prediction period can be inferred by the learned model, the inference device 200 can infer the inference observation value after the lapse of the designated prediction period by performing inference using the learned model only once.

In this case, the designated prediction period information acquired by the designated prediction period acquiring unit 204 is, for example, information indicating any date among dates from Sep. 1, 2019 to Aug. 20, 2020 corresponding to a period from one day later to 355 days later based on a time point closest to the current date and time in a period corresponding to the inference time-series data.

The inference data generating unit 205 sets, as the fifth information, information indicating the date, which is the designated prediction period information acquired by the designated prediction period acquiring unit 204.

Further, the inference data generating unit 205 generates inference data obtained by combining the fourth information and the fifth information.

Note that the designated prediction period indicated by the designated prediction period information does not need to correspond to any of the plurality of prediction periods in which the inference observation value after the lapse of the prediction period can be inferred by the learned model. In a case where the designated prediction period indicated by the designated prediction period information does not correspond to any of the plurality of prediction periods in which the inference observation value after the lapse of the prediction period can be inferred by the learned model, the inference device 200 uses the learned model to infer the inference observation value after the lapse of the designated prediction period by combining the prediction periods in which the inference observation value can be inferred so that the number of inferences is the smallest. The inference device 200 can reduce the inference error included in the inference observation value after the lapse of the designated prediction period indicated by the designated prediction period information by combining the prediction periods in which the inference observation value can be inferred so that the number of inferences is the smallest in this manner.

FIG. 10B is a diagram illustrating an example of an image displayed on the display device 12 when the result output unit 211 outputs the inference observation value and the quantile point information acquired by the result acquiring unit 210 via the display control unit 201.

In the display device 12, for example, as illustrated in FIG. 10B, the observation values in the inference time-series data are plotted and displayed in association with the observation time points.

Furthermore, the display device 12 displays the designated prediction period of the designated prediction target, for example, as illustrated in FIG. 10B.

In addition, the inference observation value after the lapse of the designated prediction period is displayed on the display device 12, for example, as illustrated in FIG. 10B.

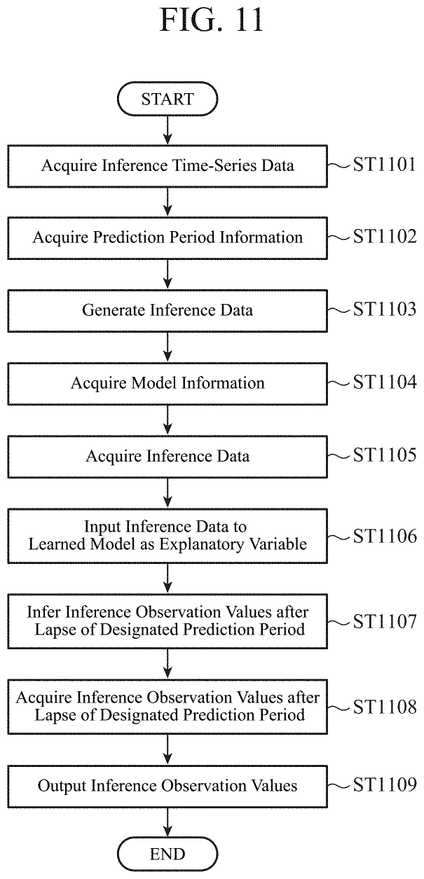

The operation of the inference device 200 according to the first embodiment will be described with reference to FIG. 11.

FIG. 11 is a flowchart illustrating an example of processing of the inference device 200 according to the first embodiment.

First, in step ST1101, the inference time-series data acquiring unit 203 acquires inference time-series data.

Next, in step ST1102, the designated prediction period acquiring unit 204 acquires designated prediction period information indicating the designated prediction period of the prediction target.

Next, in step ST1103, the inference data generating unit 205 generates inference data obtained by combining the fourth information based on the inference time-series data and the fifth information based on the designated prediction period information and capable of specifying the designated prediction period of the prediction target indicated by the designated prediction period information.

Next, in step ST1104, the model acquiring unit 206 acquires model information.

Next, in step ST1105, the inference data acquiring unit 207 acquires inference data.

Next, in step ST1106, the inference data input unit 208 inputs the inference data to the learned model as an explanatory variable.

Next, in step ST1107, the inference unit 209 uses the learned model to infer the inference observation value after a lapse of the designated prediction period.

Next, in step ST1108, the result acquiring unit 210 acquires the inference observation value after the lapse of the designated prediction period, which is output as the inference result by the learned model.

Next, in step ST1109, the result output unit 211 outputs the inference observation value acquired by the result acquiring unit 210.

After the processing of step ST1109, the inference device 200 ends the processing of the flowchart.

Note that, in the flowchart, the processing order of steps ST1101 and ST1102 does not matter as long as the processing is executed before the processing of step ST1103. In addition, the processing of step ST1104 may be executed in any order as long as it is executed before the processing of step ST1106.

As described above, the inference device 200 includes: the inference data acquiring unit 207 to acquire inference data obtained by combining fourth information based on inference time-series data including observation values in time series and fifth information capable of specifying a designated prediction period of a prediction target; the inference data input unit 208 to input the inference data acquired by the inference data acquiring unit 207 as an explanatory variable to a learned model corresponding to a learning result by machine learning; the result acquiring unit 210 to acquire an inference observation value after a lapse of the designated prediction period, the inference observation value being output as an inference result by the learned model; and the result output unit 211 to output the inference observation value acquired by the result acquiring unit 210.

With such a configuration, the inference device 200 can infer an observation value having a high inference accuracy with a small inference error in inference of any future observation value.

Furthermore, in the above-described configuration, the inference device 200 is configured so that the learned model is a learned model corresponding to a learning result by machine learning using a plurality of pieces of learning data in which information obtained by combining first information and second information in learning data obtained by combining the first information based on one of one or a plurality of pieces of time-series data including observation values in time series, the second information based on one of a plurality of prediction periods including at least two prediction periods different from each other, and third information based on observation values after a lapse of the prediction period is used as an explanatory variable, and the third information is used as a response variable.

With such a configuration, the inference device 200 can infer an observation value having a high inference accuracy with a small inference error in inference of any future observation value.

Furthermore, in the above-described configuration, the inference device 200 is configured so that the designated prediction period that can be specified by the fifth information in the inference data is a period from a time point closest to the current date and time in a period corresponding to the inference time-series data serving as a basis of the fourth information in the inference data.

With such a configuration, the inference device 200 can infer an observation value having a high inference accuracy with a small inference error in inference of any future observation value.

More specifically, with such a configuration, the inference device 200 can infer the inference observation value after the lapse of the designated prediction period from the time point closest to the current date and time in the period corresponding to the inference time-series data serving as a basis of the fourth information with high accuracy in the inference of any future observation value.

Furthermore, in the above-described configuration, the inference device 200 is configured so that the designated prediction period that can be specified by the fifth information in the inference data is a period from the occurrence time point of the predetermined event in the period corresponding to the inference time-series data serving as a basis of the fourth information in the inference data.

With such a configuration, the inference device 200 can infer an observation value having a high inference accuracy with a small inference error in inference of any future observation value.

More specifically, with such a configuration, the inference device 200 can infer the inference observation value after the lapse of the designated prediction period from the occurrence time point of the predetermined event in the period corresponding to the inference time-series data serving as a basis of the fourth information with high accuracy in the inference of any future observation value.

Furthermore, in the above-described configuration, the inference device 200 is configured so that the fifth information is information obtained by encoding the designated prediction period information capable of specifying the designated prediction period into vector representation having a predetermined number of dimensions.

With such a configuration, the inference device 200 can input the inference data obtained by combining the fourth information and the fifth information to the learned model as an explanatory variable even if the designated prediction period information indicating the designated prediction period serving as a basis of the fifth information is information represented by any unit.

Furthermore, in the above-described configuration, the inference device 200 is configured so that the fifth information is information encoded into vector representation having the predetermined same number of dimensions in all pieces of the designated prediction period information represented by any unit.

With such a configuration, the inference device 200 can input the inference data obtained by combining the fourth information and the fifth information to the learned model as an explanatory variable even if the designated prediction period information indicating the designated prediction period serving as a basis of the fifth information is information represented by any unit.

Furthermore, in the above-described configuration, the inference device 200 is configured so that the fourth information is information encoded into vector representation having the predetermined same number of dimensions in all pieces of the inference time-series data serving as a basis of the fourth information.

With such a configuration, even if the inference time-series data including the observation values in time series serving as the basis of the fourth information is time-series data including any number of observation values, the inference device 200 can input the inference data obtained by combining the fourth information and the fifth information to the learned model as an explanatory variable.

Furthermore, in the above-described configuration, the inference device 200 is configured so that the inference data input unit 208 inputs information by vector representation obtained by connecting the fourth information encoded into vector representation and the fifth information encoded into vector representation to the learned model as an explanatory variable.

With such a configuration, the inference device 200 can input the inference data obtained by combining the fourth information and the fifth information to the learned model as the explanatory variable even if the inference time-series data including the observation values in time series serving as the basis of the fourth information is time-series data including any number of observation values, or even if the designated prediction period information indicating the designated prediction period serving as the basis of the fifth information is information represented by any unit.

### Second Embodiment.

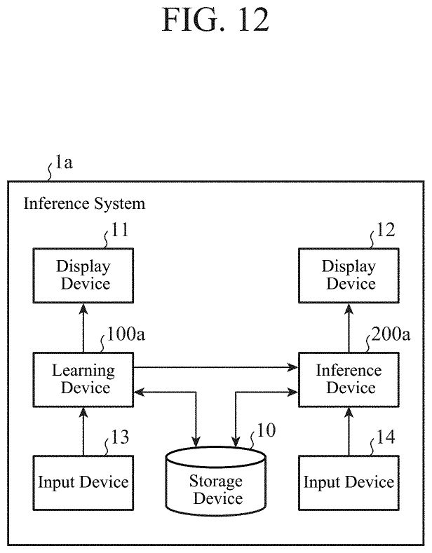

An inference system 1a according to a second embodiment will be described with reference to FIGS. 12 to 17.

FIG. 12 is a block diagram illustrating an example of a main part of the inference system 1a according to the second embodiment.

The inference system 1a according to the second embodiment is different from the inference system 1 according to the first embodiment in that the learning device 100 and the inference device 200 are changed to a learning device 100a and an inference device 200a.

In the configuration of the inference system 1a according to the second embodiment, the same reference numerals are given to the same configurations as the inference system 1 according to the first embodiment, and duplicate description thereof will be omitted. That is, the description of the configuration of FIG. 12 having the same reference numerals as those shown in FIG. 1 will be omitted.

The inference system 1a according to the second embodiment includes the learning device 100a, the inference device 200a, the storage device 10, display devices 11 and 12, and input devices 13 and 14.

The storage device 10 is a device for storing information necessary for the inference system 1a such as time-series data.

The display device 11 receives an image signal output from the learning device 100a and displays an image corresponding to the image signal.

The display device 12 receives an image signal output from the inference device 200a and performs image display corresponding to the image signal.

The input device 13 receives an operation input from the user and outputs an operation signal corresponding to the input operation of the user to the learning device 100a.

The input device 14 receives an operation input from a user and outputs an operation signal corresponding to the input operation of the user to the inference device 200a.

The learning device 100a is a device that generates a learned model by performing machine learning based on time-series data and outputs the generated learned model as model information.

The inference device 200a is a device that inputs an explanatory variable to a learned model corresponding to a learning result by machine learning, acquires an inference observation value output as an inference result by the learned model and quantile point information indicating a quantile point of the inference observation value, and outputs the acquired inference observation value and the quantile point information.

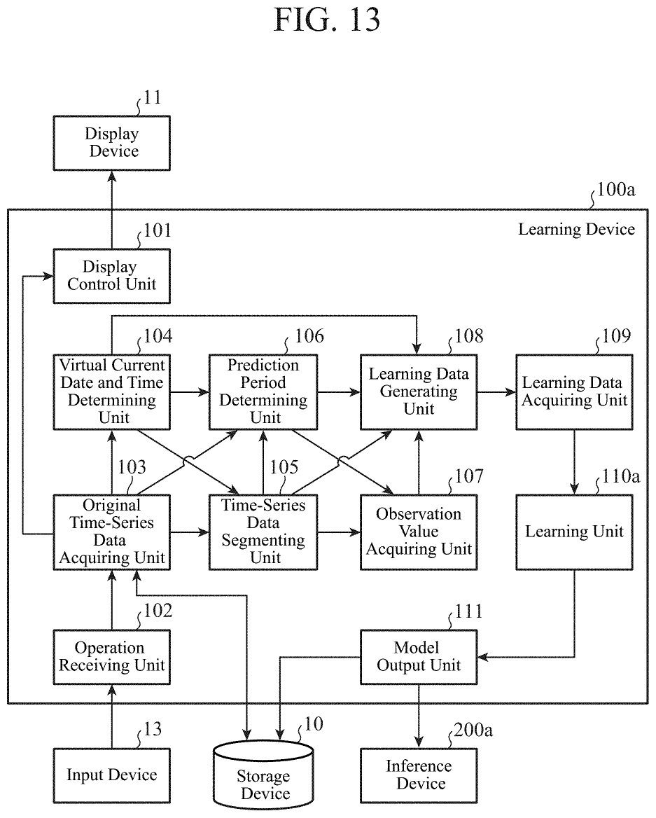

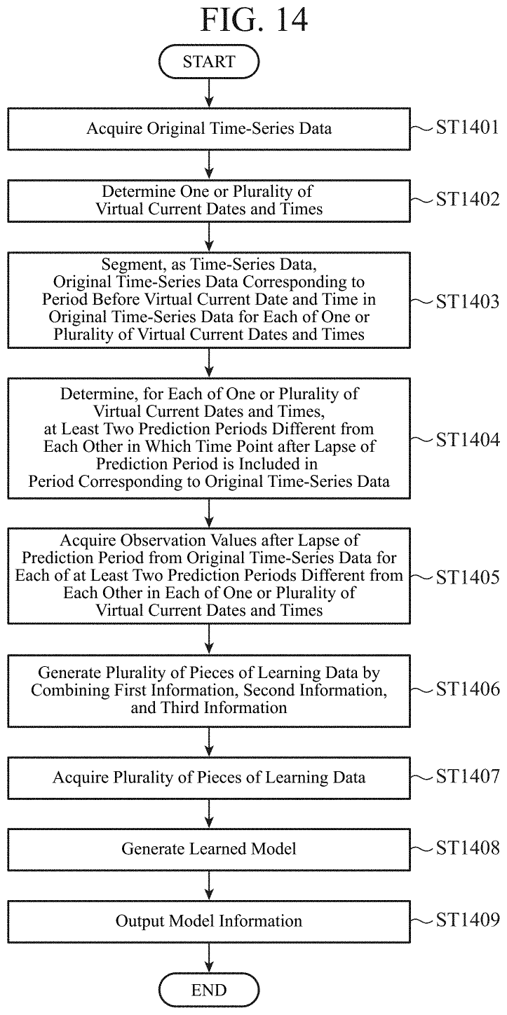

The learning device 100a according to the second embodiment will be described with reference to FIGS. 13 and 14.

FIG. 13 is a diagram showing an example of the configuration of the main part of the learning device 100a according to the second embodiment.

The learning device 100a according to the second embodiment is different from the learning device 100 according to the first embodiment in that the learning unit 110 is changed to a learning unit 110a.

In the configuration of the learning device 100a according to the second embodiment, the same reference numerals are given to the same configurations as the learning device 100 according to the first embodiment, and duplicate description thereof will be omitted. That is, the description of the configuration of FIG. 13 having the same reference numerals as those shown in FIG. 2 will be omitted.

The learning device 100a includes a display control unit 101, an operation receiving unit 102, an original time-series data acquiring unit 103, a virtual current date and time determining unit 104, a time-series data segmenting unit 105, a prediction period determining unit 106, an observation value acquiring unit 107, a learning data generating unit 108, a learning data acquiring unit 109, a learning unit 110a, and a model output unit 111.

Note that each functions of the display control unit 101, the operation receiving unit 102, the original time-series data acquiring unit 103, the virtual current date and time determining unit 104, the time-series data segmenting unit 105, the prediction period determining unit 106, the observation value acquiring unit 107, the learning data generating unit 108, the learning data acquiring unit 109, the learning unit 110a, and the model output unit 111 included in the learning device 100a may be implemented by the processor 301 and the memory 302 in the hardware configuration illustrated as an example in FIGS. 3A and 3B, or may be implemented by the processing circuit 303.

The learning unit 110a learns by using a plurality of pieces of learning data acquired by the learning data acquiring unit 109, with information obtained by combining first information and second information in the learning data as an explanatory variable and third information as a response variable. The learning unit 110a generates a learned model capable of inferring a quantile point of the inference observation values in addition to the inference observation value after the lapse of the designated prediction period by the learning.

More specifically, when learning the third information as a response variable, the learning unit 110a performs supervised machine learning using the response variable as teacher data, thereby generating a learned model capable of inferring a quantile point of the inference observation value in addition to the inference observation values after the lapse of the designated prediction period.

For example, the learning unit 110a can generate a learned model capable of inferring a quantile point of inference observation values by performing machine learning by quantile regression.

More specifically, for example, the learning unit 110a can generate a learned model capable of inferring the quantile point by performing machine learning by quantile regression for the quantile point corresponding to any designated ratio using a gradient boosting tree.

In the inference of the quantile point of the inference observation value, the learning unit 110a may generate a learned model capable of inferring a quantile point corresponding to any ratio such as 10%, 25%, 75%, or 90% in addition to the 50% quantile point corresponding to the median value in the inference of the inference observation value.

Hereinafter, the learned model generated by the learning unit 110a will be described as an example in which five quantile points corresponding to 10%, 25%, 50%, 75%, and 90% are inferred.

For example, in order to generate a learned model capable of inferring five quantile points corresponding to 10%, 25%, 50%, 75%, and 90%, the learning unit 110a performs machine learning by quantile regression for each of the five quantile points corresponding to 10%, 25%, 50%, 75%, and 90%.

Furthermore, for example, the learning unit 110a may generate a learned model that outputs an average value of inferred inference observation values and a standard deviation of the inference observation values as an inference result by performing machine learning by Gaussian process regression. The quantile point corresponding to any ratio in the inference observation values can be calculated using the cumulative density in the Gaussian distribution calculated from the average value of inference observation values output as the inference result by the learned model and the standard deviation of the inference observation values. That is, the learning unit 110a can generate a learned model capable of inferring a quantile point of inference observation values, for example, by performing machine learning by Gaussian process regression.

The operation of the learning device 100a according to the second embodiment will be described with reference to FIG. 14.

FIG. 14 is a flowchart illustrating an example of processing of the learning device 100a according to the second embodiment.

First, in step ST1401, the original time-series data acquiring unit 103 acquires original time-series data.

Next, in step ST1402, the virtual current date and time determining unit 104 determines one or more virtual current dates and times.

Next, in step ST1403, the time-series data segmenting unit 105 segments, as time-series data, original time-series data corresponding to a period before the virtual current date and time in the original time-series data for each of one or a plurality of virtual current dates and times.

Next, in step ST1404, the prediction period determining unit 106 determines, for each of one or a plurality of virtual current dates and times, at least two prediction periods different from each other in which a time point after the lapse of the prediction period is included in a period corresponding to the original time-series data.

Next, in step ST1405, the observation value acquiring unit 107 acquires the observation values after the lapse of the prediction period from the original time-series data for each of at least two prediction periods different from each other in each of one or a plurality of virtual current dates and times.

Next, in step ST1406, the learning data generating unit 108 generates a plurality of pieces of learning data by combining the first information, the second information, and the third information with one of one or a plurality of pieces of time-series data including the observation values in time series segmented by the time-series data segmenting unit 105 as the first information, prediction period information indicating one of a plurality of prediction periods including at least two prediction periods different from each other as the second information, and the observation values after the lapse of the prediction period as the third information.

Next, in step ST1407, the learning data acquiring unit 109 acquires a plurality of pieces of learning data.

Next, in step ST1408, the learning unit 110a performs learning using a plurality of pieces of learning data and generates a learned model.

Next, in step ST1409, the model output unit 111 outputs the learned model as model information.

After the processing of step ST1409, the learning device 100a ends the processing of the flowchart.

As described above, the learning device 100a includes: the learning data acquiring unit 109 to acquire a plurality of pieces of learning data in which one piece of learning data is a combination of first information based on one of one or a plurality of pieces of time-series data including observation values in time series, second information based on one of a plurality of prediction periods including at least two prediction periods different from each other, and third information based on the observation values after a lapse of the prediction period; and the learning unit 110a to perform learning using a plurality of pieces of the learning data acquired by the learning data acquiring unit 109 with information obtained by combining the first information and the second information in the learning data as an explanatory variable and the third information as a response variable, and generate a learned model capable of inferring an inference observation value after a lapse of the designated prediction period, and the learning unit 110a is configured to generate a learned model capable of inferring a quantile point of the inference observation value in addition to the inference observation value after the lapse of the designated prediction period.

With such a configuration, in the inference of any future observation value, the learning device 100a can enable inference of observation values having high inference accuracy with a small inference error and can enable inference of a quantile point of the observation values having high inference accuracy with a small inference error.

More specifically, with such a configuration, the learning device 100a can grasp the probability of correctness of the inference of the observation values with high accuracy by enabling the inference of the quantile point of the observation values having the high inference accuracy with a small inference error.

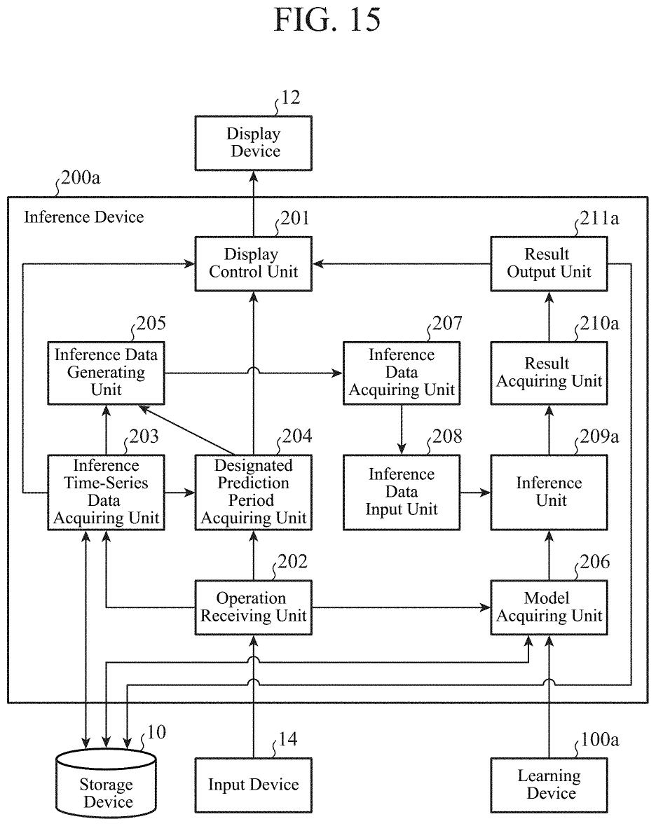

An inference device 200a according to the second embodiment will be described with reference to FIGS. 15 to 17.

FIG. 15 is a diagram showing an example of a configuration of a main part of the inference device 200a according to the second embodiment.

The inference device 200a according to the second embodiment is different from the inference device 200 according to the first embodiment in that the inference unit 209, the result acquiring unit 210, and the result output unit 211 are changed to an inference unit 209a, a result acquiring unit 210a, and a result output unit 211a.

In the configuration of the inference device 200a according to the second embodiment, the same reference numerals are given to the same configurations as the inference device 200 according to the first embodiment, and duplicate description thereof will be omitted. That is, the description of the configuration of FIG. 15 having the same reference numerals as those shown in FIG. 9 will be omitted.

The inference device 200a includes a display control unit 201, an operation receiving unit 202, an inference time-series data acquiring unit 203, a model acquiring unit 206, a designated prediction period acquiring unit 204, an inference data generating unit 205, an inference data acquiring unit 207, an inference data input unit 208, an inference unit 209a, a result acquiring unit 210a, and a result output unit 211a.

Note that each of the functions of the display control unit 201, the operation receiving unit 202, the inference time-series data acquiring unit 203, the model acquiring unit 206, the designated prediction period acquiring unit 204, the inference data generating unit 205, the inference data acquiring unit 207, the inference data input unit 208, the inference unit 209a, the result acquiring unit 210a, and the result output unit 211a included in the inference device 200a may be implemented by the processor 301 and the memory 302 in the hardware configuration illustrated as an example in FIGS. 3A and 3B, or may be implemented by the processing circuit 303.

The inference unit 209a uses the learned model indicated by the model information acquired by the model acquiring unit 206 to infer the inference observation values after the lapse of the designated prediction period and the quantile point of the inference observation values.

Note that the inference unit 209a that infers the inference observation values after the lapse of the designated prediction period designated using the learned model and the quantile point of the inference observation values may be provided in the inference device 200a or may be provided in an external device (not illustrated) connected to the inference device 200a.

As the inference result output by the learned model, the result acquiring unit 210a acquires, in addition to the inference observation values after the lapse of the designated prediction period, quantile point information indicating a quantile point of the inference observation values.

The quantile point information included in the inference result output by the learned model indicates a quantile point corresponding to any ratio such as 10%, 25%, 50%, 75%, or 90% in the inference of the inference observation values. The quantile point information may be information indicating a plurality of quantile points each corresponding to any ratios such as 10%, 25%, 50%, 75%, and 90% in the inference of the inference observation values. Hereinafter, the description will be given assuming that the quantile point information included in the inference result output by the learned model is information indicating five quantile points each corresponding to ratios of 10%, 25%, 50%, 75%, and 90%.

The result output unit 211a outputs the quantile point information acquired by the result acquiring unit 210a in addition to the inference observation value acquired by the result acquiring unit 210a.

Specifically, for example, the result output unit 211a outputs the inference observation value and the quantile point information acquired by the result acquiring unit 210a via the display control unit 201. The display control unit 201, upon receiving the inference observation value and the quantile point information from the result output unit 211a, generates an image signal corresponding to an image indicating the inference observation value and the quantile point information, outputs the image signal to the display device 12, and causes the display device 12 to display the image indicating the inference observation value and the quantile point information.

Furthermore, the result output unit 211a may output, for example, the inference observation value and the quantile point information acquired by the result acquiring unit 210a to the storage device 10, and store the inference observation value and the quantile point information in the storage device 10.

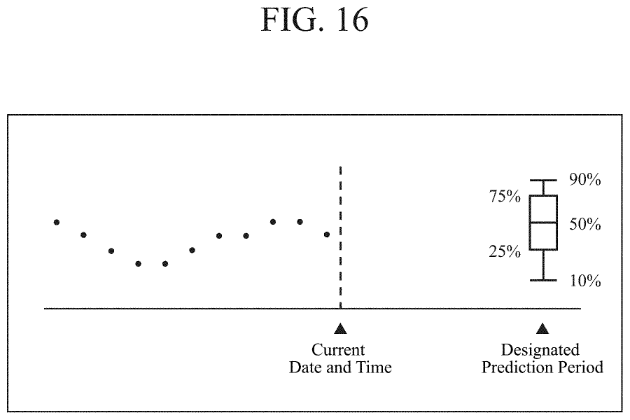

FIG. 16 is a diagram illustrating an example of an image displayed on the display device 12 when the result output unit 211a outputs the inference observation value and the quantile point information acquired by the result acquiring unit 210a via the display control unit 201.

In the display device 12, for example, as illustrated in FIG. 16, the observation values in the inference time-series data are plotted and displayed in association with the observation time points.

Furthermore, for example, as illustrated in FIG. 16, the display device 12 displays the designated prediction period of the designated prediction target.

Furthermore, on the display device 12, for example, as illustrated in FIG. 16, five quantile points each corresponding to the ratios of 10%, 25%, 50%, 75%, and 90% are displayed by a boxplot as the quantile points of the inference observation values after the lapse of the designated prediction period.

In the boxplot shown in FIG. 16, a horizontal line segment (hereinafter, referred to as a “horizontal line”.) in FIG. 16 located at an upper end of a vertical line segment (hereinafter, referred to as a “perpendicular line”) in FIG. 16 indicates a 90% quantile point, a horizontal line located at a lower end of a vertical line indicates a 10% quantile point, an upper end of a box located on the vertical line indicates a 75% quantile point, a lower end of the box indicates a 25% quantile point, and a horizontal line at a center of the box indicates a 50% quantile point.

The inference device 200a acquires the inference observation value after the lapse of the designated prediction period and the quantile point information indicating the quantile point of the inference observation value, which are output as the inference result by the learned model, and outputs the acquired inference observation values and the quantile point of the inference observation values to the display device or the like, so that the probability of correctness of the inference of the inference observation values can be grasped with high accuracy.

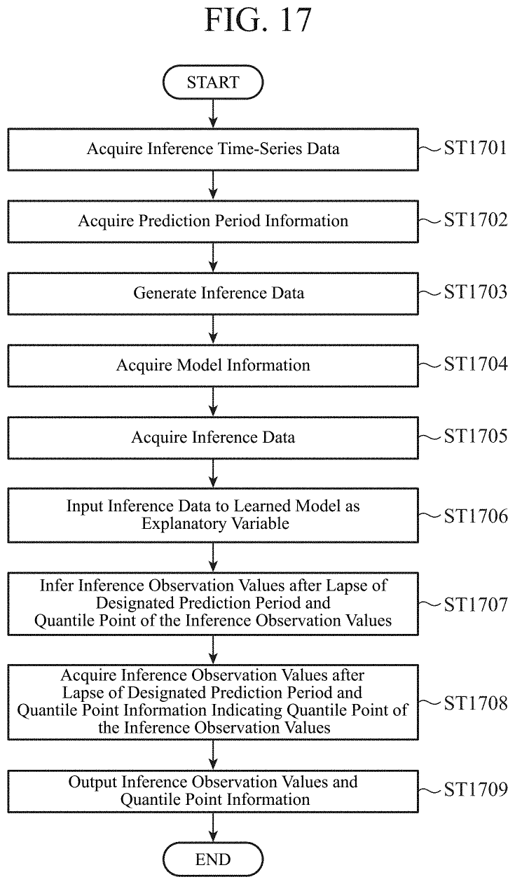

The operation of the inference device 200a according to the second embodiment will be described with reference to FIG. 17.

FIG. 17 is a flowchart illustrating an example of processing of the inference device 200a according to the second embodiment.

First, in step ST1701, the inference time-series data acquiring unit 203 acquires inference time-series data.

Next, in step ST1702, the designated prediction period acquiring unit 204 acquires designated prediction period information indicating the designated prediction period of the prediction target.

Next, in step ST1703, the inference data generating unit 205 generates inference data obtained by combining the fourth information based on the inference time-series data and the fifth information based on the designated prediction period information and capable of specifying the designated prediction period of the prediction target indicated by the designated prediction period information.

Next, in step ST1704, the model acquiring unit 206 acquires model information.

Next, in step ST1705, the inference data acquiring unit 207 acquires inference data.

Next, in step ST1706, the inference data input unit 208 inputs the inference data to the learned model as an explanatory variable.

Next, in step ST1707, the inference unit 209a uses the learned model to infer the inference observation values after the lapse of the designated prediction period and the quantile point of the inference observation values.

Next, in step ST1708, the result acquiring unit 210a acquires the inference observation values after the lapse of the designated prediction period and the quantile point information indicating the quantile point of the inference observation values, which are output as the inference result by the learned model.

Next, in step ST1709, the result output unit 211a outputs the inference observation values and the quantile point information acquired by the result acquiring unit 210a.

After the processing of step ST1709, the inference device 200a ends the processing of the flowchart.

Note that, in the flowchart, the processing order of steps ST1701 and ST1702 does not matter as long as the processing is executed before the processing of step ST1703. In addition, the processing of step ST1704 may be executed in any order as long as it is executed before the processing of step ST1706.

As described above, the inference device 200a includes the inference data acquiring unit 207 to acquire inference data obtained by combining fourth information based on inference time-series data including observation values in time series and fifth information capable of specifying a designated prediction period of a prediction target; the inference data input unit 208 to input the inference data acquired by the inference data acquiring unit 207 as an explanatory variable to a learned model corresponding to a learning result by machine learning; the result acquiring unit 210a to acquire an inference observation value after a lapse of the designated prediction period, the inference observation value being output as an inference result by the learned model; and the result output unit 211a to output the inference observation value acquired by the result acquiring unit 210a, in which the result acquiring unit 210a acquires, as the inference result output by the learned model, the quantile point information indicating the quantile point of the inference observation value in addition to the inference observation values after the lapse of the designated prediction period, and the result output unit 211a outputs the quantile point information acquired by the result acquiring unit 210a in addition to the inference observation values acquired by the result acquiring unit 210a.

With such a configuration, the inference device 200a can infer the observation values having high inference accuracy with a small inference error in the inference of any future observation value, and further, can grasp the probability of correctness of the inference of the observation values with high accuracy.

### Third Embodiment.

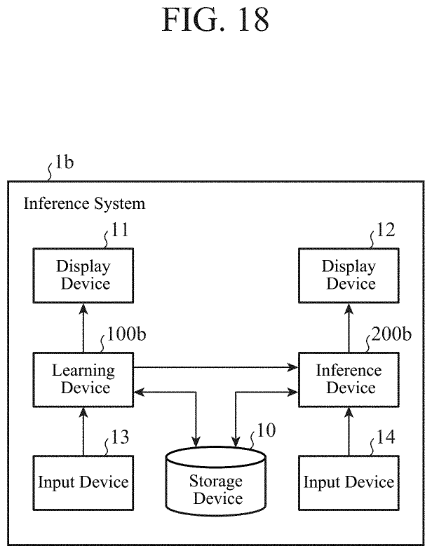

An inference system 1b according to a third embodiment will be described with reference to FIGS. 18 to 23.

FIG. 18 is a block diagram illustrating an example of a main part of the inference system 1b according to the third embodiment.

The inference system 1b according to the third embodiment is different from the inference system 1 according to the first embodiment in that the learning device 100 and the inference device 200 are changed to a learning device 100b and an inference device 200b.

In the configuration of the inference system 1b according to the third embodiment, the same reference numerals are given to the same configurations as the inference system 1 according to the first embodiment, and duplicate description thereof will be omitted. That is, the description of the configuration of FIG. 18 having the same reference numerals as those shown in FIG. 1 will be omitted.

The inference system 1b according to the third embodiment includes the learning device 100b, the inference device 200b, the storage device 10, display devices 11 and 12, and input devices 13 and 14.

The storage device 10 is a device for storing information necessary for the inference system 1b such as time-series data.

The display device 11 receives an image signal output from the learning device 100b and displays an image corresponding to the image signal.

The display device 12 receives an image signal output from the inference device 200b and displays an image corresponding to the image signal.

The input device 13 receives an operation input from a user and outputs an operation signal corresponding to the input operation of the user to the learning device 100b.

The input device 14 receives an operation input from the user and outputs an operation signal corresponding to the input operation of the user to the inference device 200b.

The learning device 100b is a device that generates a learned model by performing machine learning based on time-series data and outputs the generated learned model as model information.

The inference device 200b is a device that inputs an explanatory variable to a learned model corresponding to a learning result by machine learning, acquires inference observation values output as an inference result by the learned model and predicted distribution information indicating a predicted distribution of the inference observation values, and outputs the acquired inference observation values and predicted distribution information.

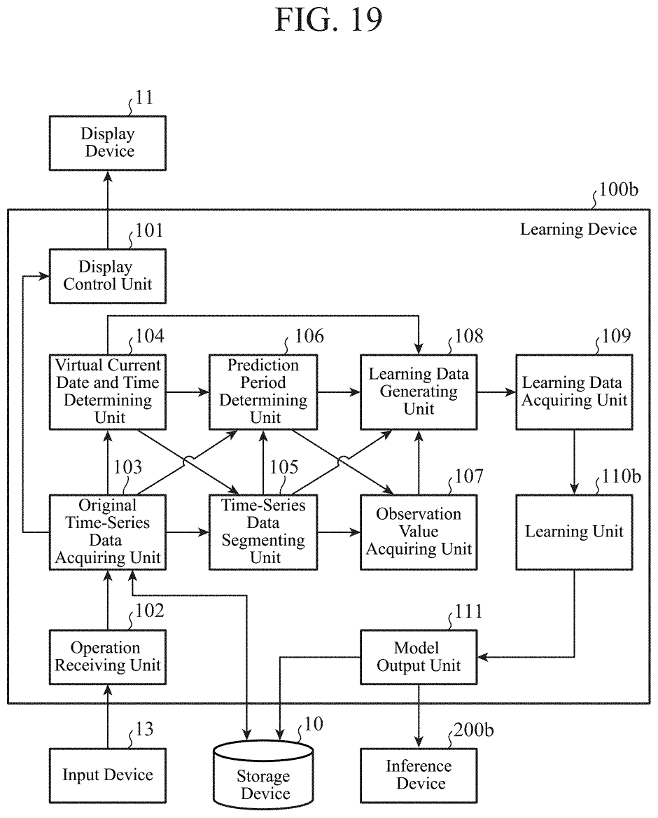

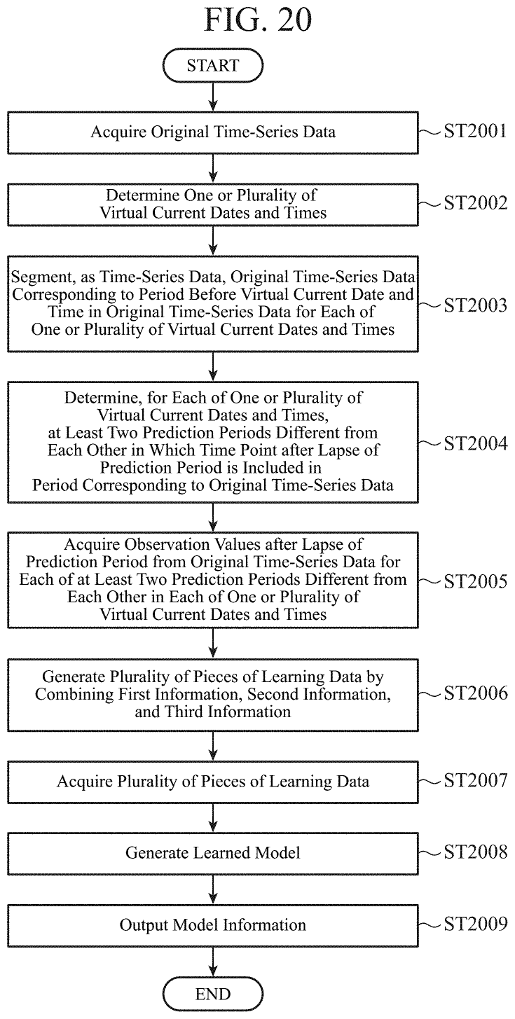

The learning device 100b according to the third embodiment will be described with reference to FIGS. 19 and 20.

FIG. 19 is a block diagram illustrating an example of a configuration of a main part of the learning device 100b according to the third embodiment.

The learning device 100b according to the third embodiment is different from the learning device 100 according to the first embodiment in that the learning unit 110 is changed to a learning unit 110b.

In the configuration of the learning device 100b according to the third embodiment, the same reference numerals are given to the same configurations as the learning device 100 according to the first embodiment, and duplicate description thereof will be omitted. That is, the description of the configuration of FIG. 19 having the same reference numerals as those shown in FIG. 2 will be omitted.

The learning device 100b includes a display control unit 101, an operation receiving unit 102, an original time-series data acquiring unit 103, a virtual current date and time determining unit 104, a time-series data segmenting unit 105, a prediction period determining unit 106, an observation value acquiring unit 107, a learning data generating unit 108, a learning data acquiring unit 109, a learning unit 110b, and a model output unit 111.

Note that each of the functions of the display control unit 101, the operation receiving unit 102, the original time-series data acquiring unit 103, the virtual current date and time determining unit 104, the time-series data segmenting unit 105, the prediction period determining unit 106, the observation value acquiring unit 107, the learning data generating unit 108, the learning data acquiring unit 109, the learning unit 110b, and the model output unit 111 included in the learning device 100b may be implemented by the processor 301 and the memory 302 in the hardware configuration illustrated as an example in FIGS. 3A and 3B, or may be implemented by the processing circuit 303.

The learning unit 110b learns by using a plurality of pieces of learning data acquired by the learning data acquiring unit 109, with information obtained by combining the first information and the second information in the learning data as an explanatory variable and the third information as a response variable. The learning unit 110b generates a learned model capable of inferring a predicted distribution of the inference observation values in addition to the inference observation values after the lapse of the designated prediction period by the learning.

More specifically, when learning the third information as a response variable, the learning unit 110b performs supervised machine learning using the response variable as teacher data, thereby generating a learned model capable of inferring a predicted distribution of the inference observation values in addition to the inference observation values after the lapse of the designated prediction period.

The learning unit 110b can generate a learned model capable of inferring a predicted distribution of inference observation values by performing machine learning using, for example, mixture density networks (MDN) obtained by applying a mixture density model to a neural network.

The observation value may take only a predetermined value such as 1.0 or 3.0 among a plurality of predetermined discrete values such as 1.0 and 3.0.

The learning unit 110b can grasp that the inference observation value is an inappropriate value in a case where a value (for example, 2.0) between two values (for example, 1.0 and 3.0) close to each other among a plurality of predetermined discrete values is the inference observation value by generating a learned model capable of inferring the predicted distribution of the inference observation values.

The operation of the learning device 100b according to the third embodiment will be described with reference to FIG. 20.

FIG. 20 is a flowchart illustrating an example of processing of the learning device 100b according to the third embodiment.

First, in step ST2001, the original time-series data acquiring unit 103 acquires original time-series data.

Next, in step ST2002, the virtual current date and time determining unit 104 determines one or a plurality of virtual current dates and times.

Next, in step ST2003, the time-series data segmenting unit 105 segments, as time-series data, original time-series data corresponding to a period before the virtual current date and time in the original time-series data for each of one or a plurality of virtual current dates and times.

Next, in step ST2004, the prediction period determining unit 106 determines, for each of one or a plurality of virtual current dates and times, at least two prediction periods different from each other in which a time point after the lapse of the prediction period is included in a period corresponding to the original time-series data.

Next, in step ST2005, the observation value acquiring unit 107 acquires the observation values after the lapse of the prediction period from the original time-series data for each of at least two prediction periods different from each other in each of one or a plurality of virtual current dates and times.

Next, in step ST2006, the learning data generating unit 108 generates a plurality of pieces of learning data by combining the first information, the second information, and the third information with one of one or a plurality of pieces of time-series data including the observation values in time series segmented by the time-series data segmenting unit 105 as the first information, prediction period information indicating one of a plurality of prediction periods including at least two prediction periods different from each other as the second information, and the observation values after the lapse of the prediction period as the third information.

Next, in step ST2007, the learning data acquiring unit 109 acquires a plurality of pieces of learning data.

Next, in step ST2008, the learning unit 110b performs learning using a plurality of pieces of learning data to generate a learned model.

Next, in step ST2009, the model output unit 111 outputs the learned model as model information.

After the processing of step ST2009, the learning device 100b ends the processing of the flowchart.

As described above, the learning device 100b includes: the learning data acquiring unit 109 to acquire a plurality of pieces of learning data in which one piece of learning data is a combination of first information based on one of one or a plurality of pieces of time-series data including observation values in time series, second information based on one of a plurality of prediction periods including at least two prediction periods different from each other, and third information based on the observation values after a lapse of the prediction period; and the learning unit 110b to perform learning using a plurality of pieces of the learning data acquired by the learning data acquiring unit 109 with information obtained by combining the first information and the second information in the learning data as an explanatory variable and the third information as a response variable, and generate a learned model capable of inferring an inference observation value after a lapse of the designated prediction period, in which the learning unit 110b is configured to generate a learned model capable of inferring a predicted distribution of the inference observation values in addition to the inference observation values after a lapse of a designated prediction period.

With such a configuration, in the inference of any future observation value, the learning device 100b can enable the inference of the observation values having high inference accuracy with a small inference error and can enable the inference of the predicted distribution of the observation values having high inference accuracy with a small inference error.

More specifically, with such a configuration, in a case where a value between two values close to each other among a plurality of predetermined discrete values that can be taken by the observation values is the inference observation value, the learning device 100b can grasp that the inference observation value is an inappropriate value with high accuracy.

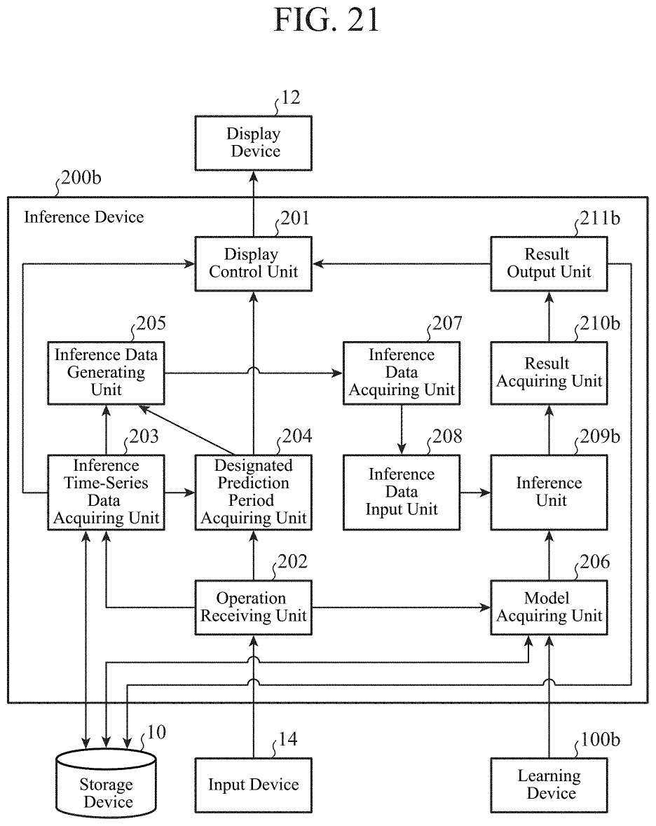

The inference device 200b according to the third embodiment will be described with reference to FIGS. 21 to 23.

FIG. 21 is a block diagram illustrating an example of a configuration of a main part of the inference device 200b according to the third embodiment.

The inference device 200b according to the third embodiment is different from the inference device 200 according to the first embodiment in that the inference unit 209, the result acquiring unit 210, and the result output unit 211 are changed to an inference unit 209b, a result acquiring unit 210b, and a result output unit 211b.

In the configuration of the inference device 200b according to the third embodiment, the same reference numerals are given to the same configurations as the inference device 200 according to the first embodiment, and duplicate description thereof will be omitted. That is, the description of the configuration of FIG. 21 having the same reference numerals as those shown in FIG. 9 will be omitted.

The inference device 200b includes a display control unit 201, an operation receiving unit 202, an inference time-series data acquiring unit 203, a model acquiring unit 206, a designated prediction period acquiring unit 204, an inference data generating unit 205, an inference data acquiring unit 207, an inference data input unit 208, an inference unit 209b, a result acquiring unit 210b, and a result output unit 211b.

Note that each of the functions of the display control unit 201, the operation receiving unit 202, the inference time-series data acquiring unit 203, the model acquiring unit 206, the designated prediction period acquiring unit 204, the inference data generating unit 205, the inference data acquiring unit 207, the inference data input unit 208, the inference unit 209b, the result acquiring unit 210b, and the result output unit 211b included in the inference device 200b may be implemented by the processor 301 and the memory 302 in the hardware configuration illustrated as an example in FIGS. 3A and 3B, or may be implemented by the processing circuit 303.

The inference unit 209b uses the learned model indicated by the model information acquired by the model acquiring unit 206 to infer the inference observation values after the lapse of the designated prediction period and the predicted distribution of the inference observation values.

Note that the inference unit 209b that infers the inference observation values and the predicted distribution of the inference observation values after the lapse of the designated prediction period designated using the learned model may be provided in the inference device 200b or may be provided in an external device (not illustrated) connected to the inference device 200b.

The result acquiring unit 210b acquires, as the inference result output by the learned model, predicted distribution information indicating a predicted distribution of the inference observation values in addition to the inference observation values after the lapse of the designated prediction period.

The predicted distribution information included in the inference result output by the learned model indicates, for each inference observation value, a probability that the inference observation values can be taken in the inference of the inference observation values.

The result output unit 211b outputs the predicted distribution information acquired by the result acquiring unit 210b in addition to the inference observation values acquired by the result acquiring unit 210b.

Specifically, for example, the result output unit 211b outputs the inference observation values and the predicted distribution information acquired by the result acquiring unit 210b via the display control unit 201. The display control unit 201, upon receiving the inference observation values and the predicted distribution information from the result output unit 211b, generates an image signal corresponding to an image indicating the inference observation values and the predicted distribution information, outputs the image signal to the display device 12, and causes the display device 12 to display an image indicating the inference observation values and the predicted distribution information.

Furthermore, the result output unit 211b may output, for example, the inference observation values and the predicted distribution information acquired by the result acquiring unit 210b to the storage device 10 and cause the storage device 10 to store the inference observation values and the predicted distribution information.

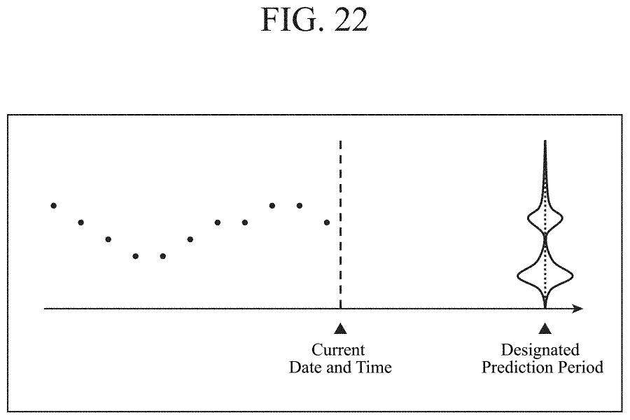

FIG. 22 is a diagram illustrating an example of an image displayed on the display device 12 when the result output unit 211b outputs the inference observation values and the predicted distribution information acquired by the result acquiring unit 210b via the display control unit 201.

On the display device 12, for example, as illustrated in FIG. 22, the observation values in the inference time-series data are plotted and displayed in association with the observation time points.

Furthermore, for example, as illustrated in FIG. 22, the display device 12 displays the designated prediction period of the designated prediction target.

Furthermore, on the display device 12, for example, as illustrated in FIG. 22, the predicted distribution of the inference observation values after the lapse of the designated prediction period is displayed by a violin plot.

In the violin plot illustrated in FIG. 22, an upper bulge in the vertical direction in FIG. 22 indicates a probability that the inference observation values are in the vicinity of 3.0, and a lower bulge indicates a probability that the inference observation values are in the vicinity of 1.0.

In the predicted distribution illustrated in FIG. 22, in a case where both the probability that the observation value after the lapse of the designated prediction period is 3.0 and the probability that the observation value is 1.0 are 50%, the learned model may output an inference result indicating that the inference observation value is 2.0.

The inference device 200b acquires the inference observation values after the lapse of the designated prediction period and the predicted distribution information indicating the predicted distribution of the inference observation values, which are output as the inference result by the learned model, and outputs the acquired inference observation values and the predicted distribution of the inference observation values to the display device or the like, thereby making it possible to grasp with high accuracy that the inference observation value is inappropriate. Furthermore, the inference device 200b can grasp with high accuracy that the observation value after the lapse of the designated prediction period is 1.0 or 3.0.

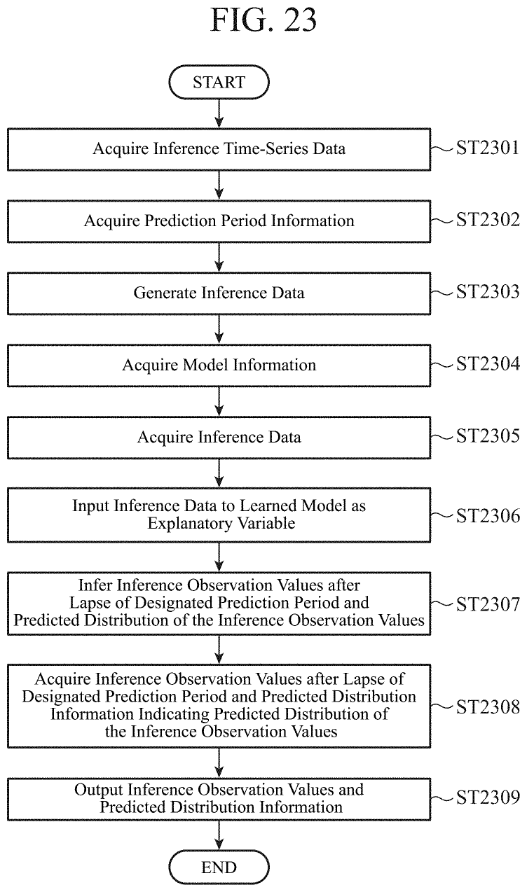

The operation of the inference device 200b according to the third embodiment will be described with reference to FIG. 23.

FIG. 23 is a flowchart illustrating an example of processing of the inference device 200b according to the third embodiment.

First, in step ST2301, the inference time-series data acquiring unit 203 acquires inference time-series data.

Next, in step ST2302, the designated prediction period acquiring unit 204 acquires designated prediction period information indicating the designated prediction period of the prediction target.

Next, in step ST2303, the inference data generating unit 205 generates inference data obtained by combining the fourth information based on the inference time-series data and the fifth information based on the designated prediction period information and capable of specifying the designated prediction period of the prediction target indicated by the designated prediction period information.

Next, in step ST2304, the model acquiring unit 206 acquires model information.

Next, in step ST2305, the inference data acquiring unit 207 acquires inference data.

Next, in step ST2306, the inference data input unit 208 inputs the inference data to the learned model as an explanatory variable.

Next, in step ST2307, the inference unit 209b uses the learned model to infer the inference observation values after the lapse of the designated prediction period and the predicted distribution of the inference observation values.

Next, in step ST2308, the result acquiring unit 210b acquires the inference observation values after the lapse of the designated prediction period and the predicted distribution information indicating the predicted distribution of the inference observation values, which are output as the inference result by the learned model.

Next, in step ST2309, the result output unit 211b outputs the inference observation values and the predicted distribution information acquired by the result acquiring unit 210b.

After the processing of step ST2309, the inference device 200b ends the processing of the flowchart.

Note that, in the flowchart, the processing order of steps ST2301 and ST2302 does not matter as long as the processing is executed before the processing of step ST2303. In addition, the processing of step ST2304 may be executed in any order as long as it is executed before the processing of step ST2306.

As described above, the inference device 200b includes: the inference data acquiring unit 207 to acquire inference data obtained by combining fourth information based on time-series data including observation values in time series and fifth information capable of specifying a designated prediction period of a prediction target; the inference data input unit 208 to input the inference data acquired by the inference data acquiring unit 207 as an explanatory variable to a learned model corresponding to a learning result by machine learning; the result acquiring unit 210b to acquire an inference observation value after a lapse of the designated prediction period, the inference observation value being output as an inference result by the learned model; and the result output unit 211b to output the inference observation value acquired by the result acquiring unit 210b, in which the result acquiring unit 210b acquires the predicted distribution information indicating the predicted distribution of the inference observation values in addition to the inference observation values after the lapse of the designated prediction period as the inference result output by the learned model, and the result output unit 211b outputs the predicted distribution information acquired by the result acquiring unit 210b in addition to the inference observation values acquired by the result acquiring unit 210b.

With such a configuration, the inference device 200b can infer an inference observation value having high inference accuracy with a small inference error in inference of any future observation value, and further, can grasp with high accuracy that the inference observation value is an inappropriate value. Furthermore, in a case where the inference observation value is an inappropriate value, the inference device 200b can grasp an appropriate value with high accuracy.

### Fourth Embodiment.

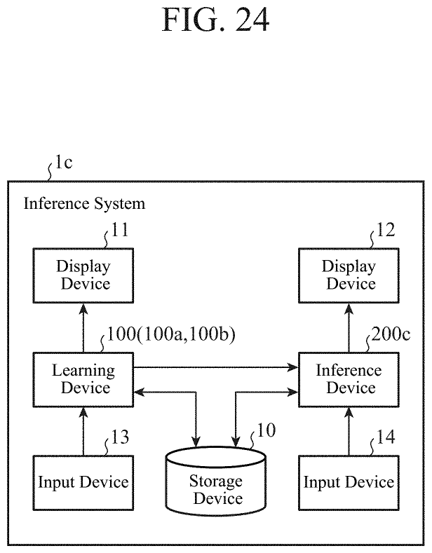

An inference system 1c according to a fourth embodiment will be described with reference to FIGS. 24 to 29.

FIG. 24 is a block diagram illustrating an example of a main part of the inference system 1c according to the fourth embodiment.

The inference system 1c according to the fourth embodiment is different from the inference system 1 according to the first embodiment in that the inference device 200 is changed to an inference device 200c.

In the configuration of the inference system 1c according to the fourth embodiment, the same reference numerals are given to the same configurations as the inference system 1 according to the first embodiment, and duplicate description thereof will be omitted. That is, the description of the configuration of FIG. 24 having the same reference numerals as those shown in FIG. 1 will be omitted.

The inference system 1c according to the fourth embodiment includes a learning device 100, the inference device 200c, a storage device 10, display devices 11 and 12, and input devices 13 and 14.

The storage device 10 is a device for storing information necessary for the inference system 1c such as time-series data.

The display device 12 receives an image signal output from the inference device 200c and displays an image corresponding to the image signal.

The input device 14 receives an operation input from a user and outputs an operation signal corresponding to the input operation of the user to the inference device 200c.

The inference device 200c is a device that inputs an explanatory variable to a learned model corresponding to a learning result by machine learning and outputs an inference observation value output as an inference result by the learned model.

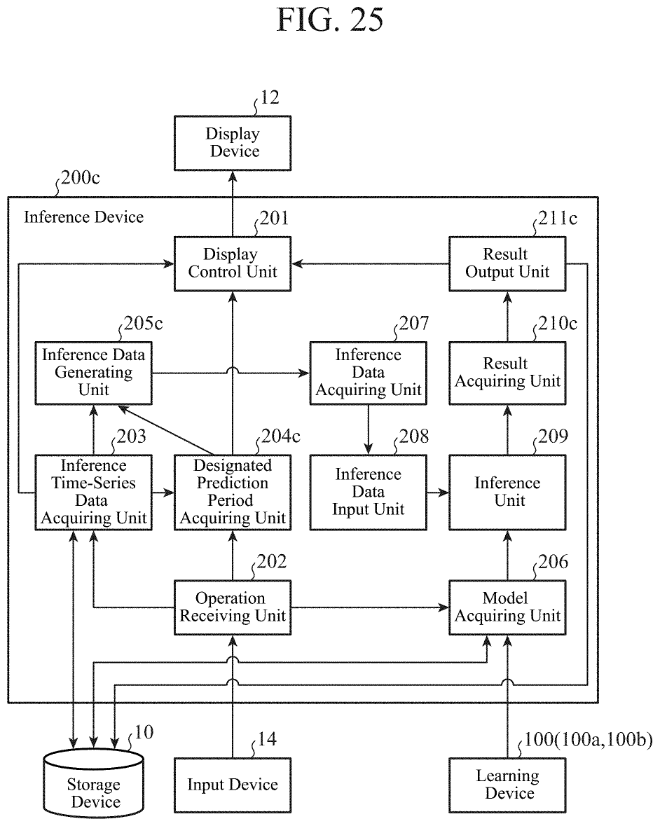

The inference device 200c according to the fourth embodiment will be described with reference to FIGS. 25 to 29.

FIG. 25 is a block diagram showing an example of a configuration of a main part of the inference device 200c according to the fourth embodiment.

The inference device 200c according to the fourth embodiment is different from the inference device 200 according to the first embodiment in that the result acquiring unit 210 and the result output unit 211 are changed to a result acquiring unit 210c and a result output unit 211c.

In the configuration of the inference device 200c according to the fourth embodiment, the same reference numerals are given to the same configurations as the inference device 200 according to the first embodiment, and duplicate description thereof will be omitted. That is, the description of the configuration of FIG. 25 having the same reference numerals as those shown in FIG. 9 will be omitted.

The inference device 200c includes a display control unit 201, an operation receiving unit 202, an inference time-series data acquiring unit 203, a model acquiring unit 206, a designated prediction period acquiring unit 204c, an inference data generating unit 205c, an inference data acquiring unit 207, an inference data input unit 208, an inference unit 209, the result acquiring unit 210c, and the result output unit 211c.

Note that each of the functions of the display control unit 201, the operation receiving unit 202, the inference time-series data acquiring unit 203, the model acquiring unit 206, the designated prediction period acquiring unit 204c, the inference data generating unit 205c, the inference data acquiring unit 207, the inference data input unit 208, the inference unit 209, the result acquiring unit 210c, and the result output unit 211c included in the inference device 200c may be implemented by the processor 301 and the memory 302 in the hardware configuration illustrated in FIGS. 3A and 3B as an example, or may be implemented by the processing circuit 303.

The designated prediction period acquiring unit 204c acquires designated prediction period information indicating the designated prediction period of the prediction target.

The designated prediction period acquiring unit 204c can acquire, as the designated prediction period information, designated prediction period information indicating up to one time point that is a prediction target, designated prediction period information indicating up to a plurality of time points that are prediction targets, or designated prediction period information indicating a time range of the prediction target (hereinafter referred to as “prediction range”) represented by a range over two time points different from each other. That is, the designated prediction period acquiring unit 204 according to the first embodiment acquires the designated prediction period information indicating one time point that is a prediction target as the designated prediction period information. On the other hand, the designated prediction period acquiring unit 204c can acquire, as the designated prediction period information, designated prediction period information indicating a plurality of time points that are prediction targets or designated prediction period information indicating a prediction range that is a prediction target, in addition to the designated prediction period information indicating one time point that is a prediction target.

For example, the user uses the input device 14 to designate a plurality of time points, thereby inputting a plurality of time points that are prediction targets to designate a designated prediction period, or to designate two time points different from each other, thereby inputting a prediction range that is a prediction target to designate a designated prediction period.

The designated prediction period acquiring unit 204c, upon receiving an operation signal output from the input device 14 as operation information via the operation receiving unit 202, converts the designated prediction period indicated by the operation information into the designated prediction period information to acquire the designated prediction period information.

The inference data generating unit 205c generates inference data obtained by combining the fourth information based on the inference time-series data acquired by the inference time-series data acquiring unit 203 and the fifth information based on the designated prediction period information acquired by the designated prediction period acquiring unit 204c and capable of specifying the designated prediction period of the prediction target indicated by the designated prediction period information.

The fifth information in the inference data generated by the inference data generating unit 205c is information capable of specifying one or more time points that are prediction targets or a prediction range that is a prediction target.

Note that the inference data generating unit 205c may set, as the fifth information, information obtained by encoding the designated prediction period information capable of specifying the designated prediction period into vector representation having a predetermined number of dimensions, for example. The method by which the inference data generating unit 205c encodes the designated prediction period information capable of specifying the designated prediction period into vector representation having the predetermined number of dimensions is similar to the method by which the second information generating unit 182a in the learning device 100 encodes the prediction period information into vector representation having the predetermined number of dimensions when generating the second information, and thus the description thereof will be omitted.

In particular, the fifth information is preferably information encoded into vector representation having the predetermined same number of dimensions in all pieces of the designated prediction period information represented by any unit such as one or more time points that are prediction targets or a prediction range that is a prediction target.

The result acquiring unit 210c acquires the inference observation values after the lapse of the designated prediction period output as the inference result by the learned model.

The learned model outputs, as the inference result, an inference observation value at each of one or more time points that are prediction targets, or one or more inference observation values within a prediction range that is a prediction target. Therefore, the result acquiring unit 210c acquires, as the inference observation values after the lapse of the designated prediction period, inference observation values at each of one or more time points that are prediction targets or one or more inference observation values within a prediction range that is a prediction target.

The result output unit 211c outputs the inference observation values acquired by the result acquiring unit 210c.

Specifically, for example, the result output unit 211c outputs the inference observation values at each of one or more time points that are prediction targets acquired by the result acquiring unit 210c or one or more inference observation values within the prediction range that is a prediction target.

More specifically, for example, the result output unit 211c outputs the inference observation values at each of the one or more time points that are prediction targets acquired by the result acquiring unit 210c or the one or more inference observation values within the prediction range that is a prediction target via the display control unit 201. The display control unit 201, upon receiving the inference observation values at each of one or more time points that are prediction targets or one or more inference observation values within the prediction range that is a prediction target from the result output unit 211c, and generates an image signal corresponding to an image indicating the inference observation values. The display control unit 201 outputs the image signal to the display device 12 and causes the display device 12 to display an image indicating the inference observation values.

Furthermore, the result output unit 211c may output, for example, the inference observation values at each of the one or more time points that are prediction targets acquired by the result acquiring unit 210c or the one or more inference observation values within the prediction range that is a prediction target to the storage device 10 and cause the storage device 10 to store the inference observation values.

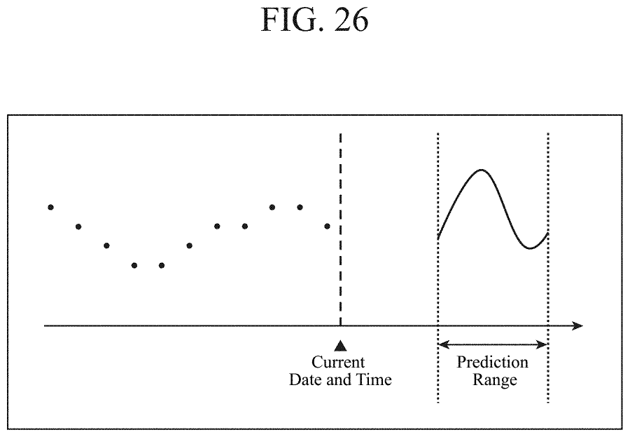

FIG. 26 is a diagram illustrating an example of an image displayed on the display device 12 when the result output unit 211c outputs one or more inference observation values within the prediction range that is the prediction target acquired by the result acquiring unit 210c via the display control unit 201.

On the display device 12, for example, as illustrated in FIG. 26, the observation values in the inference time-series data are plotted and displayed in association with the observation time points.

Furthermore, for example, as illustrated in FIG. 26, a prediction range that is a designated prediction target is displayed on the display device 12.

Furthermore, on the display device 12, for example, as illustrated in FIG. 26, inference observation values within a prediction range that is a designated prediction target are displayed.

With such a configuration, the inference device 200c can grasp how the inference observation values at each of one or more time points that are designated prediction targets or one or more inference observation values within the prediction range that is the prediction target change.

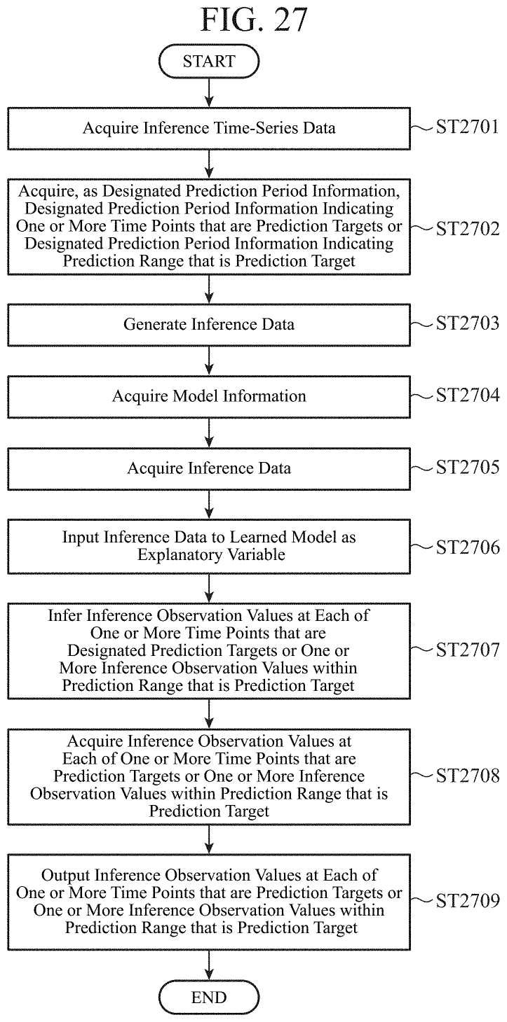

The operation of the inference device 200c according to the fourth embodiment will be described with reference to FIG. 27.

FIG. 27 is a flowchart illustrating an example of processing of the inference device 200c according to the fourth embodiment.

First, in step ST2701, the inference time-series data acquiring unit 203 acquires inference time-series data.

Next, in step ST2702, the designated prediction period acquiring unit 204c acquires, as the designated prediction period information, designated prediction period information indicating one or more time points that are prediction targets or designated prediction period information indicating a prediction range that is a prediction target.

Next, in step ST2703, the inference data generating unit 205 generates inference data obtained by combining the fourth information based on the inference time-series data and the fifth information capable of specifying the designated prediction period of the prediction target.

Next, in step ST2704, the model acquiring unit 206 acquires model information.

Next, in step ST2705, the inference data acquiring unit 207 acquires inference data.

Next, in step ST2706, the inference data input unit 208 inputs the inference data to the learned model as an explanatory variable.

Next, in step ST2707, the inference unit 209 uses the learned model to infer the inference observation values at each of one or more time points that are designated prediction targets or one or more inference observation values within the prediction range that is the prediction target.

Next, in step ST2708, the result acquiring unit 210c acquires inference observation values at each of one or more time points that are prediction targets or one or more inference observation values within a prediction range that is a prediction target, which are output as an inference result by the learned model.

Next, in step ST2709, the result output unit 211c outputs the inference observation values at each of one or more time points that are the prediction targets acquired by the result acquiring unit 210c or one or more inference observation values within the prediction range that is the prediction target.

After the processing of step ST2709, the inference device 200c ends the processing of the flowchart.

Note that, in the flowchart, the processing order of steps ST2701 and ST2702 does not matter as long as the processing is executed before the processing of step ST2703. In addition, the processing of step ST2704 may be executed in any order as long as it is executed before the processing of step ST2706.

Note that, in the inference system 1c according to the fourth embodiment, the learning device 100 may be changed to the learning device 100a according to the second embodiment, and further, the inference device 200c may be modified to a device, such as the inference device 200a illustrated in the second embodiment, that acquires the quantile point information indicating the quantile point of the inference observation values as the inference result from the learned model and outputs the acquired quantile point information.

With such a configuration, the inference device 200c can grasp the inference observation values at each of one or more time points that are designated prediction targets or one or more inference observation values within the prediction range that is the prediction target, and also can grasp the quantile point of the inference observation values.

Furthermore, in the inference system 1c according to the fourth embodiment, the learning device 100 may be changed to the learning device 100b according to the third embodiment, and the inference device 200c may be modified to a device, such as the inference device 200b described in the third embodiment, that acquires predicted distribution information indicating a predicted distribution of inference observation values as an inference result from a learned model and outputs the acquired predicted distribution information.

With such a configuration, the inference device 200c can grasp the inference observation values at each of one or more time points that are designated prediction targets or one or more inference observation values within the prediction range that is the prediction target, and also can grasp the predicted distribution of the inference observation values.

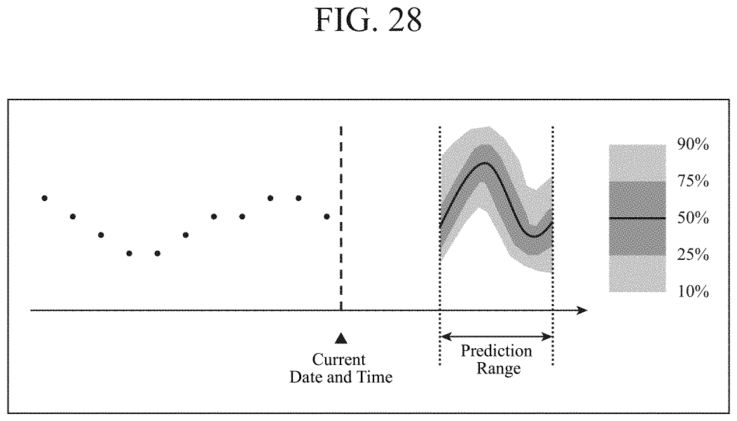

FIG. 28 is a diagram illustrating an example of an image displayed on the display device 12 when the result output unit 211c outputs, via the display control unit 201, the respective quantile points of one or more inference observation values within the prediction range that is the prediction target acquired by the result acquiring unit 210c.

On the display device 12, for example, as illustrated in FIG. 28, the observation values in the inference time-series data are plotted and displayed in association with the observation time points.

Furthermore, for example, as illustrated in FIG. 28, a prediction range that is a designated prediction target is displayed on the display device 12.

In addition, for example, as illustrated in FIG. 28, the display device 12 displays respective quantile points of one or more inference observation values within a prediction range that is a designated prediction target.

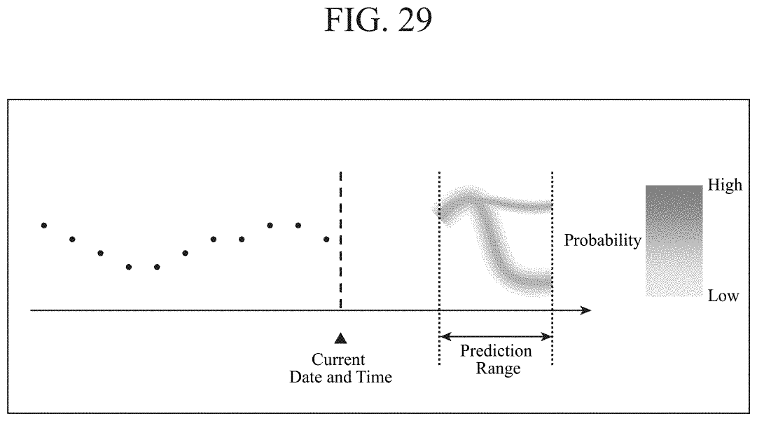

FIG. 29 is a diagram illustrating an example of an image displayed on the display device 12 when the result output unit 211c outputs, via the display control unit 201, a predicted distribution of one or more inference observation values within a prediction range that is a prediction target acquired by the result acquiring unit 210c.

On the display device 12, for example, as illustrated in FIG. 28, the observation values in the inference time-series data are plotted and displayed in association with the observation time points.

Furthermore, for example, as illustrated in FIG. 28, a prediction range that is a designated prediction target is displayed on the display device 12.

In addition, for example, as illustrated in FIG. 28, the display device 12 displays respective predicted distributions of one or more inference observation values within a prediction range that is a designated prediction target.

As described above, the inference device 200c includes the inference data acquiring unit 207 to acquire the inference data obtained by combining the fourth information based on the time-series data including the observation values in time series and the fifth information capable of specifying the designated prediction period of the prediction target, the inference data input unit 208 to input the inference data acquired by the inference data acquiring unit 207 to the learned model corresponding to the learning result by machine learning as an explanatory variable, the result acquiring unit 210c to acquire the inference observation values after the lapse of the designated prediction period output by the learned model as the inference result, and the result output unit 211c to output the inference observation values acquired by the result acquiring unit 210c, in which the designated prediction period of the prediction target that can be specified by the fifth information is one or more time points that are the prediction targets or a prediction range that is the prediction target, and the result acquiring unit 210c acquires, as the inference observation values after the lapse of the designated prediction period, which is output as the inference result by the learned model, the inference observation values at each of one or more time points that are the prediction targets or one or more inference observation values within the prediction range that is the prediction target, and the result output unit 211c is configured to output the inference observation values at each of one or more time points that are the prediction targets acquired by the result acquiring unit 210c or one or more inference observation values within the prediction range that is the prediction target.

With such a configuration, the inference device 200c can infer observation values having high inference accuracy with a small inference error in inference of any future observation value.

Furthermore, with such a configuration, the inference device 200c can grasp how the inference observation values at each of one or more time points that are the designated prediction targets or one or more inference observation values within the prediction range that is the prediction target change.

Furthermore, in the above-described configuration, the inference device 200c may be configured so that the result acquiring unit 210c acquires, as the inference result output by the learned model, one or more pieces of quantile point information indicating a quantile point of each of the inference observation values, in addition to the inference observation values at each of one or more time points that are prediction targets or one or more inference observation values within the prediction range that is a prediction target as the inference observation value after the lapse of the designated prediction period, and the result output unit 211c outputs the quantile point information acquired by the result acquiring unit 210a, in addition to the inference observation values at each of one or more time points that are prediction targets acquired by the result acquiring unit 210a or one or more inference observation values within the prediction range that is a prediction target.

With such a configuration, the inference device 200c can infer the observation values having high inference accuracy with a small inference error in the inference of any future observation value, and further, can grasp the probability of correctness of the inference of the observation values with high accuracy.

Furthermore, with such a configuration, the inference device 200c can grasp how the inference observation values at each of one or more time points that are the designated prediction targets or one or more inference observation values within the prediction range that is the prediction target change, and also can grasp the probability of correctness of inference of each of the inference observation values with high accuracy.

Furthermore, in the above-described configuration, the inference device 200c may be configured so that the result acquiring unit 210c acquires, as the inference result output by the learned model, one or more pieces of predicted distribution information indicating a predicted distribution of each of the inference observation values, in addition to the inference observation values at each of one or more time points that are prediction targets or one or more inference observation values within the prediction range that is a prediction target, as the inference observation values after the lapse of the designated prediction period, and the result output unit 211c outputs the predicted distribution information acquired by the result acquiring unit 210a, in addition to the inference observation values at each of one or more time points that are prediction targets acquired by the result acquiring unit 210a or one or more inference observation values within the prediction range that is a prediction target.

With such a configuration, the inference device 200c can infer inference observation values having high inference accuracy with a small inference error in inference of any future observation value, and further, can grasp with high accuracy that the inference observation value is an inappropriate value. Furthermore, the inference device 200c can grasp an appropriate value with high accuracy in a case where the inference observation value is an inappropriate value.

Furthermore, with such a configuration, the inference device 200c can grasp how the inference observation values at each of one or more time points that are designated prediction targets or one or more inference observation values within the prediction range that is a prediction target change, and also can grasp with high accuracy that each of the inference observation values is an inappropriate value. Furthermore, the inference device 200c can grasp an appropriate value with high accuracy in a case where the inference observation value is an inappropriate value.

Note that, in the first embodiment, an example in which the number of entering people is inferred by the inference system 1 has been described, but it is not limited thereto. For example, the inference system 1 can also be applied to demand prediction, failure prediction, or the like of a product or the like.

It should be noted that the present invention can freely combine the embodiments, modify any constituent element of each embodiment, or omit any constituent element in each embodiment within the scope of the invention.

### INDUSTRIAL APPLICABILITY

The learning device according to the present invention can be applied to an inference system.

### REFERENCE SIGNS LIST

1, 1a, 1b, 1c: inference system, 10: storage device, 11, 12: display device, 13, 14: input device, 100, 100a, 100b: learning device, 101: display control unit, 102: operation receiving unit, 103: original time-series data acquiring unit, 104: virtual current date and time determining unit, 105: time-series data segmenting unit, 106: prediction period determining unit, 107: observation value acquiring unit, 108: learning data generating unit, 109: learning data acquiring unit, 110, 110a, 110b: learning unit, 111: model output unit, 181, 181a: first information generating unit, 182, 182a: second information generating unit, 183: third information generating unit, 184: information combining unit, 200, 200a, 200b, 200c: inference device, 201: display control unit, 202: operation receiving unit, 203: inference time-series data acquiring unit, 204, 204c: designated prediction period acquiring unit, 205, 205c: inference data generating unit, 206: model acquiring unit, 207: inference data acquiring unit, 208: inference data input unit, 209, 209a, 209b: inference unit, 210, 210a, 210b, 210c: result acquiring unit, 211, 211a, 211b, 211c: result output unit, 301: processor, 302: memory, 303: processing circuit

1. A learning device, comprising:
processing circuitry to perform a process to:
acquire a plurality of pieces of learning data in which one piece of learning data is a combination of first information based on one of one or a plurality of pieces of time-series data including observation values in time series, second information based on one of a plurality of prediction periods including at least two prediction periods different from each other, and third information based on the observation values after a lapse of the prediction period; and
perform learning using a plurality of pieces of the learning data acquired with information obtained by combining the first information and the second information in the learning data as an explanatory variable and the third information as a response variable, and generate a learned model capable of inferring an inference observation value after a lapse of the designated prediction period, wherein the second information is information obtained by encoding prediction period information capable of specifying the prediction period into vector representation having a predetermined number of dimensions, the process further to:
determine one or a plurality of virtual current dates and times, which are virtually determined current dates and times, from a period corresponding to one piece of original time-series data including the observation values in time series;
segment, for each of one or a plurality of the virtual current dates and times determined, the original time-series data corresponding to a period before the virtual current date and time in the original time-series data as the time-series data including the observation values in time series that serve as a basis of the first information;
determine, for each of one or a plurality of the virtual current dates and times determined, at least the two prediction periods that are different from each other and serve as a basis of the second information, a time point after a lapse of the prediction period being included in a period corresponding to the original time-series data;
acquire, for each of at least the two prediction periods different from each other determined, the observation values after a lapse of the prediction period that serve as a basis of the third information, from the original time-series data; and
generate a plurality of pieces of the learning data by combining the first information based on one of one or a plurality of pieces of the time-series data including the observation values in time series segmented, the second information based on one of a plurality of the prediction periods including at least the two prediction periods different from each other determined, and the third information based on the observation values after a lapse of the prediction period acquired, wherein
the process acquires a plurality of pieces of the learning data generated.

2. The learning device according to claim 1, wherein
the prediction period that serves as a basis of the second information in the learning data is a period from a time point closest to a current date and time in a period corresponding to the time-series data that serves as a basis of the first information in the learning data, and
the third information in the learning data is information based on the observation values after the lapse of the prediction period from the time point.

3. The learning device according to claim 1, wherein
the prediction period that serves as a basis of the second information in the learning data is a period from an occurrence time point of a predetermined event in a period corresponding to the time-series data that serves as a basis of the first information in the learning data, and
the third information in the learning data is information based on the observation values after a lapse of the prediction period from the occurrence time point of the event.

4. The learning device according to claim 1, wherein the second information is information encoded into vector representation having a predetermined same number of dimensions in all the prediction period information represented by any unit.

5. The learning device according to claim 1, wherein the first information is information encoded into vector representation having a predetermined same number of dimensions in all the time-series data that serve as a basis of the first information.

6. The learning device according to claim 5, wherein the process learns, as the explanatory variable, information based on vector representation obtained by connecting the first information encoded into vector representation and the second information encoded into vector representation.

7. The learning device according to claim 1, wherein the process generates the learned model capable of inferring a quantile point of the inference observation values in addition to the inference observation values after a lapse of the designated prediction period.

8. The learning device according to claim 1, wherein the process generates the learned model capable of inferring a predicted distribution of the inference observation values in addition to the inference observation values after the lapse of the designated prediction period.

9. A learning data generation device, comprising:
processing circuitry to perform a process to:
determine one or a plurality of virtual current dates and times, which are virtually determined current dates and times, from a period corresponding to one piece of original time-series data including observation values in time series;
segment, for each of one or a plurality of the virtual current dates and times determined, the original time-series data corresponding to a period before the virtual current date and time in the original time-series data as time-series data including the observation values in time series that serve as a basis of first information;
determine, for each of one or a plurality of the virtual current dates and times determined, at least two prediction periods that are different from each other and serve as a basis of second information, a time point after a lapse of a prediction period being included in a period corresponding to the original time-series data;
acquire, for each of at least the two prediction periods different from each other determined, the observation values after the lapse of the prediction period that serve as a basis of third information, from the original time-series data; and
generate a plurality of pieces of learning data by combining the first information based on one of one or a plurality of pieces of the time-series data including the observation values in time series segmented, the second information based on one of a plurality of the prediction periods including at least the two prediction periods different from each other determined, and the third information based on the observation values after the lapse of the prediction period acquired, wherein the second information is information obtained by encoding prediction period information capable of specifying the prediction period into vector representation having a predetermined number of dimensions.

10. An inference device, comprising:
processing circuitry to perform a process to:
acquire inference data obtained by combining fourth information based on inference time-series data including observation values in time series and fifth information capable of specifying a designated prediction period of a prediction target;
input the inference data acquired as an explanatory variable to a learned model corresponding to a learning result by the learning device according to claim 1;
acquire an inference observation value after a lapse of the designated prediction period, the inference observation value being output as an inference result by the learned model; and
output the inference observation value acquired, wherein the fifth information is information obtained by encoding prediction period information capable of specifying the prediction period into vector representation having a predetermined number of dimensions.

11. The inference device according to claim 10, wherein the designated prediction period that can be specified by the fifth information in the inference data is a period from a time point closest to a current date and time in a period corresponding to the inference time-series data that serves as a basis of the fourth information in the inference data.

12. The inference device according to claim 10, wherein the designated prediction period that can be specified by the fifth information in the inference data is a period from an occurrence time point of a predetermined event in a period corresponding to the inference time-series data that serves as a basis of the fourth information in the inference data.

13. The inference device according to claim 10, wherein the fifth information is information encoded into vector representation having a predetermined same number of dimensions in all the designated prediction period information represented by any unit.

14. The inference device according to claim 10, wherein the fourth information is information encoded into vector representation having a predetermined same number of dimensions in all the inference time-series data that serve as a basis of the fourth information.

15. The inference device according to claim 14, wherein the process inputs information by vector representation obtained by connecting the fourth information encoded into vector representation and the fifth information encoded into vector representation to the learned model as the explanatory variable.

16. The inference device according to claim 10, wherein
the process acquires, as the inference result output by the learned model, quantile point information indicating a quantile point of the inference observation values in addition to the inference observation values after the lapse of the designated prediction period, and
the process outputs the quantile point information acquired in addition to the inference observation values acquired.

17. The inference device according to claim 10, wherein
the process acquires, as the inference result output by the learned model, predicted distribution information indicating a predicted distribution of the inference observation values in addition to the inference observation values after the lapse of the designated prediction period, and
the process outputs the predicted distribution information acquired in addition to the inference observation values acquired.

18. The inference device according to claim 10, wherein the learned model is the learned model corresponding to the learning result by the machine learning, the learned model being learned using a plurality of pieces of the learning data by using, as an explanatory variable, information obtained by combining first information and second information in learning data obtained by combining the first information based on one of one or a plurality of pieces of time-series data including the observation values in time series, the second information based on one of a plurality of prediction periods including at least two prediction periods different from each other, and third information based on the observation values after a lapse of the prediction period, and using the third information as a response variable.
